(19) United States
(12) Patent Application Publication
(10) Pub. No.: US 2020/0063673 A1
(43) Pub. Date: Feb. 27, 2020

(54) ENGINE SYSTEM

(71) Applicant: AISAN KOGYO KABUSHIKI KAISHA, Obu-shi, Aichi (JP)

(72) Inventors: Mamoru YOSHIOKA, Nagoya-shi (JP); Shinji KAWAI, Gifu-shi (JP); Takehide NAKAMURA, Handa-shi (JP); Masanori ITO, Inazawa-shi (JP)

(73) Assignee: AISAN KOGYO KABUSHIKI KAISHA, Obu-shi, Aichi (JP)

(21) Appl. No.: 16/485,969

(22) PCT Filed: Dec. 14, 2017
(86) PCT No.: PCT/JP2017/044871

§ 371 Date: Aug. 14, 2019

(30) Foreign Application Priority Data
Mar. 23, 2017 (JP) 2017-058029

(51) Int. Cl. F02D 41/00; F02D 41/18

(52) U.S. Cl. CPC F02D 41/0007; F02D 2041/0017; F02D 41/18

(57) ABSTRACT

The engine system includes: an engine equipped with a supercharger; an electronic throttle device; a low-pressure loop EGR device including an EGR valve; a fresh air introduction device; and an electronic control unit (ECU). The fresh air introduction device includes a fresh air introduction passage and a fresh air introduction valve for introducing fresh air to an intake passage disposed downstream of the electronic throttle device. The electronic throttle device is configured with a DC motor type, and the fresh air introduction valve is configured with a step motor type. Upon determining that the engine is decelerating, the ECU causes the EGR valve to close fully and the fresh air introduction valve to open to a predetermined degree, while also controlling the electronic throttle device to close to a predetermined opening degree, thereby adjusting the total intake amount to the engine.

### TECHNICAL FIELD

The present invention relates to an engine system that includes an engine provided with a supercharger, an intake amount regulation valve to regulate an intake amount of intake air to the engine, an EGR device (including an EGR valve) of a low-pressure loop type that allows EGR gas to recirculate through the engine, a fresh air introduction device (including a fresh air introduction valve) that introduces fresh air to downstream of the intake amount regulation valve, and is configured to control the EGR valve, the intake amount regulation valve, and the fresh air introduction valve during deceleration of the engine.

### BACKGROUND ART

As this type of conventional technique, a “control apparatus for an internal combustion engine” described in Patent Literature 1 indicated below is known, for example. This control apparatus is formed with an internal combustion engine (engine) provided with a supercharger, a throttle valve (an intake amount regulation valve) to regulate the intake amount to the engine, an EGR device (including an EGR valve) of a low-pressure loop type that allows EGR gas to recirculate through the engine, a fresh air introduction device (including a supplementary intake amount regulation valve (fresh air introduction valve)) that introduces fresh air to downstream of the intake amount regulation valve, and an electronic control unit (ECU) that controls those elements. Even if an engine system including an EGR device of a low-pressure loop type controls an EGR valve to decrease the flow rate of EGR gas according to deceleration of an engine, decrease in the flow rate of EGR gas is delayed. Consequently, influence of EGR gas remaining in an intake passage may cause misfire of the engine. To address this, when an ECU of the above-mentioned control apparatus controls a fresh air introduction valve to open to allow a fresh-air introduction amount to be a desired target value and controls an intake amount regulation valve to close to allow an intake amount of intake air supplied to the engine to be a predetermined target value when the ECU determines that the engine decelerates and the influence of EGR gas remaining in the intake passage causes misfire of the engine.

### RELATED ART DOCUMENTS

### Patent Documents

Patent Document 1: JP 5277351 B2

### SUMMARY OF INVENTION

### Problems to be Solved by the Invention

However, the ECU of the control apparatus described in Patent Document 1 controls the fresh air introduction valve to open when the ECU determines both deceleration and misfire of the engine, that is, when misfire on deceleration is determined. Accordingly, a fresh air introduction valve is delayed in its valve-opening, and thus fresh air is delayed to be introduced to an intake passage, and thus there is possibility of failure of preventing misfire of the engine. If the fresh air introduction valve is controlled to open with delay in response to closing control of the intake amount regulation valve, the remaining EGR gas is not sufficiently diluted due to delay in increase of fresh air. Accordingly, misfire may not be prevented.

An electrically operated valve may generally have slight delay in response (delayed valve-opening) from a start of response (input of control signal) to completion of response (reaching a predetermined opening degree). That is, it may take time. Therefore, a configuration is demanded to prevent misfire even if a fresh air introduction valve has such a delay in response.

The present invention is made in view of the above circumstances and an object of the present invention is to provide an engine system that uses both an intake amount regulation valve and a fresh air introduction valve during deceleration of an engine, and thereby appropriately prevents misfire of the engine caused by the influence of the remaining EGR gas.

### Means of Solving the Problems

(1) To achieve the above-mentioned object, one aspect of the present invention provides an engine system comprising: an engine; an intake passage to introduce intake air to the engine; an exhaust passage to discharge exhaust gas from the engine; a supercharger provided in the intake passage and the exhaust passage to increase pressure of intake air in the intake passage, the supercharger including a compressor placed in the intake passage, a turbine placed in the exhaust passage, and a rotary shaft connecting the compressor to the turbine to allow the compressor and the turbine to integrally rotate; an intake amount regulation valve placed in the intake passage to regulate an intake amount of intake air flowing in the intake passage; an exhaust gas recirculation device including an exhaust gas recirculation passage to allow a part of exhaust gas discharged to the exhaust passage from the engine to flow through the intake passage and recirculate to the engine as exhaust gas recirculation gas, and an exhaust gas recirculation valve to regulate a flow rate of exhaust gas recirculation gas in the exhaust gas recirculation passage, the exhaust gas recirculation passage including an inlet connected to the exhaust passage downstream of the turbine and an outlet connected to the intake passage upstream of the compressor; a fresh air introduction passage to introduce fresh air to the intake passage downstream of the intake amount regulation valve, the fresh air introduction passage including an inlet connected to the intake passage upstream of the outlet of the exhaust gas recirculation passage; a fresh air introduction valve to regulate an introduction amount of fresh air flowing to the intake passage from the fresh air introduction passage; an operation state detecting unit to detect an operation state of the engine; and a controller to control the intake amount regulation valve, the exhaust gas recirculation valve, and the fresh air introduction valve based on the detected operation state, wherein the controller is configured to control the fresh air introduction valve to open to a predetermined fresh-air opening degree according to the detected operation state, and the controller controls the exhaust gas recirculation valve to fully close when the controller determines deceleration of the engine based on the detected operation state, controls the fresh air introduction valve to open to the predetermined fresh-air opening degree, and controls the intake amount regulation valve to a predetermined intake opening degree, and thus regulates a total amount of intake air introduced to the engine.

According to the configuration (1), the controller controls the exhaust recirculation valve to fully close when the controller determines deceleration of the engine based on an operation state detected by the operation state detecting unit. At that time, the exhaust gas recirculation gas having entered the intake passage before the exhaust gas recirculation valve is controlled to be fully closed may remain in the intake passage, and when a ratio of the remaining exhaust gas recirculation gas is high, the exhaust gas recirculation gas which is to be introduced to the engine with the intake air may cause misfire of the engine. According to the configuration (1), when the controller determines deceleration of the engine, without determining occurrence of misfire of the engine, the controller controls the fresh air introduction valve to open to a predetermined fresh-air opening degree and controls the intake amount regulation valve to close to the predetermined intake opening degree so that a total intake amount of intake air introduced to the engine is regulated. Thus, when the controller determines deceleration of the engine, fresh air is quickly introduced to the intake passage downstream of the intake amount regulation valve, and a total amount of intake air including intake air having passed through the intake amount regulation valve added with fresh air is quickly regulated to an appropriate amount.

(2) To achieve the above object, in the above configuration (1), preferably, when the controller determines deceleration of the engine based on the detected operation state during not-increase in pressure when pressure of the intake air is not increased to positive pressure, the controller controls the exhaust gas recirculation valve to fully close, controls the fresh air introduction valve to open from a fully closed state to the predetermined fresh-air opening degree, and after a start of opening control of the fresh air introduction valve, controls the intake amount regulation valve to close to the predetermined intake opening degree.

According to the configuration (2), when the controller determines deceleration of the engine during not-increase in pressure, without determining occurrence of misfire of the engine, the controller controls the fresh air introduction valve to open from the fully closed state to the predetermined fresh-air opening degree and after the start of opening control of the fresh air introduction valve, controls the intake amount regulation valve to close to the predetermined intake opening degree. Thus, when the controller determines deceleration of the engine during not-increase in pressure, the fresh air is promptly introduced to the intake passage downstream of the intake amount regulation valve, so that the remaining exhaust gas recirculation gas is diluted and the total amount of intake air including the intake air having passed through the intake amount regulation valve added with the fresh air is quickly regulated to the appropriate amount.

(3) To achieve the above object, in the above configuration (1), preferably, the controller is configured to control the fresh air introduction valve to open to a predetermined fresh-air opening degree during not-increase in pressure when pressure of the intake air is not increased to positive pressure, and when the controller determines deceleration of the engine based on the detected operation state during not-increase in pressure, the controller controls the exhaust gas recirculation valve to fully close, holds a valve-opening state of the fresh air introduction valve that has been controlled to open to the predetermined fresh-air opening degree, and controls the intake amount regulation valve to close to the predetermined intake opening degree.

According to the above configuration (3), the controller controls the fresh air introduction valve to open to the predetermined fresh-air opening degree during not-increase in pressure. Further, when the controller determines deceleration of the engine during not-increase in pressure, the controller holds the valve-opening state of the fresh air introduction valve that has been controlled to open to the predetermined fresh-air opening degree, and controls the intake amount regulation valve to close to the predetermined intake opening degree.

Thus, when the controller determines deceleration of the engine during not-increase in pressure, the fresh air passes through the fresh air introduction valve which has been opened, and the fresh air is then promptly introduced to the intake passage downstream of the intake amount regulation valve. As a result of this, the exhaust gas recirculation gas remaining in the intake passage is diluted, and the total amount of intake air including the intake air having passed through the intake amount regulation valve added with the fresh air is quickly regulated to the appropriate amount.

(4) To achieve the above purpose, in the above configuration (3), preferably, the controller is provided with a target fresh-air opening degree map set in advance with a predetermined fresh-air opening degree corresponding to the operation state of the engine, the predetermined fresh-air opening degree including a fully closed position, a maximum opening degree, and various intermediate opening degrees between the fully closed position and the maximum opening degree, the controller sets the predetermined fresh-air opening degree to the maximum opening degree corresponding to the operation state of the engine at a start of deceleration of the engine by referring to the target fresh-air opening degree map when the controller determines deceleration of the engine during not-increase in pressure so that the controller holds the valve-opening state of the fresh air introduction valve that has been controlled to open to the predetermined fresh-air opening degree, the controller sets the predetermined fresh-air opening degree to the fully closed position by referring to the target fresh-air opening degree map during pressure increase when the supercharger increases pressure of intake air to positive pressure so that the controller controls the fresh air introduction valve to open to the predetermined fresh-air opening degree, and the controller determines the predetermined fresh-air opening degree by referring to the target fresh-air opening degree map when the controller determines deceleration of the engine during pressure increase so that the controller controls the fresh air introduction valve to open from a fully closed state to the predetermined fresh-air opening degree after the intake pressure has decreased to negative pressure.

According to the above configuration (4), in addition to operations of the above (3), the controller sets the predetermined fresh-air opening degree corresponding to the operation state of the engine by referring to the target fresh-air opening degree map, and thus the fresh air introduced to the intake passage is appropriately regulated according to the operation state of the engine. In other words, when the controller determines deceleration of the engine during not-increase in pressure, the controller sets the fresh air opening degree to the maximum opening degree corresponding to the operation state of the engine by referring to the target fresh-air opening degree map so that the controller holds the valve-opening state of the fresh air introduction valve that has been controlled to open to the predetermined fresh-air opening degree. Accordingly, when the engine decelerates during not-increase in pressure, the fresh air introduction valve is kept open to the optimum maximum opening degree corresponding to the operation state of the engine. Further, during pressure increase, the controller sets the predetermined fresh-air opening degree of the fresh air introduction valve to the fully closed position by referring to the target fresh-air opening degree map. Consequently, during pressure increase, the fresh air introduction valve is controlled to fully close, and the fresh air introduction passage is shut off. Further, when the controller determines deceleration of the engine during pressure increase, the controller determines the predetermined fresh-air opening degree by referring to the target fresh-air opening degree map so that the controller controls the fresh air introduction valve to open from the fully closed state to the predetermined fresh-air opening degree after the intake pressure has decreased to negative pressure. Accordingly, in deceleration of the engine during pressure increase, the controller controls the fresh-air introduction valve to open to the optimum fresh air opening degree corresponding to the operation state of the engine from the fully-closed state after the intake pressure decreases to negative pressure.

(5) To achieve the above object, in the configuration of any one of the above (1) to (4), preferably, the controller calculates a target intake amount of the engine corresponding to the operation state detected at a start of deceleration of the engine, calculates a fresh-air introduction amount corresponding to the predetermined fresh-air opening degree, calculates a passing intake amount of intake air having passed through the intake amount regulation valve by subtracting the fresh-air introduction amount from the target intake amount and calculates the predetermined intake opening degree based on the passing intake amount.

According to the above configuration (5), in addition to operations of the above configurations (1) to (4), the controller calculates the predetermined intake opening degree based on the passing intake amount by subtracting the fresh air introduction amount from the target intake amount of the engine. Accordingly, the intake amount of the intake air passing through the intake amount regulation valve is regulated with no excess or no shortage by the controller's controlling of the intake amount regulation valve to open to the predetermined intake opening degree.

(6) To achieve the above purpose, in the configuration of any one of the above (1) to (5), preferably, the controller gradually decreases the opening degree of the fresh air introduction valve from the predetermined fresh-air opening degree in association with decrease in a ratio of the exhaust gas recirculation gas remaining in the intake passage decreased by introduction of fresh air from the fresh-air introduction passage to the intake passage and gradually increases the opening degree of the intake amount regulation valve according to the gradual decrease in the opening degree of the fresh air introduction valve.

According to the above configuration (6), in addition to the operations of the above (1) to (5), the controller gradually decreases the opening degree of the fresh air introduction valve from the predetermined fresh-air opening degree in association with decrease in the ratio of the remaining exhaust gas recirculation gas and gradually increases the opening degree of the intake amount regulation valve according to the gradual decrease in the fresh air opening degree. Accordingly, the fresh air introduction valve is closed without any sudden change in the total intake amount of the intake air introduced to the engine, and the intake amount regulation valve is regulated to the desired intake opening degree.

(7) To achieve the above object, in the above configuration (6), preferably, the controller once holds the opening degree of the fresh air introduction valve to the predetermined fresh-air opening degree before the gradual decrease in the opening degree of the fresh air introduction valve from the predetermined fresh-air opening degree.

According to the above configuration (7), in addition to the operation of the above (6), the controller once holds the opening degree of the fresh air introduction valve to the predetermined fresh-air opening degree before the gradual decrease in the opening degree of the fresh air introduction valve from the predetermined fresh-air opening degree. Accordingly, the desired fresh-air introduction amount is assured before starting decrease in the fresh air to be introduced to the intake passage.

(8) To achieve the above object, in the above configuration (5), preferably, the intake amount regulation valve is configured by an electrically operated valve of a direct current motor type, and the fresh air introduction valve is configured by an electrically operated valve of a step motor type, and the controller increases the predetermined intake opening degree to be calculated by a predetermined value with expecting delay in opening of the fresh air introduction valve.

In general, an electrically operated valve of a DC motor type has high responsivity, but costs much and tends to be in a large size. On the other hand, an electrically operated valve of a step motor type has low responsivity, but costs less and can be made compact. According to the above configuration (8), in addition to the operation of the above configuration (5), the intake amount regulation valve is configured by an electrically operated valve of a DC motor type and thus has relatively high responsivity. On the other hand, the fresh air introduction valve is configured by an electrically operated valve of a step motor type and thus has relatively low responsivity. Herein, the controller increases the predetermined intake opening degree to be calculated by a predetermined value with expecting delay in valve opening of the fresh air introduction valve with low responsivity. Accordingly, when the engine decelerates, even if introduction of the fresh air to the intake passage is delayed, the deficient amount of the fresh air is compensated for by this increase in the intake air.

(9) To achieve the above object, in the above configuration (2), preferably, the intake amount regulation valve is configured by an electrically operated valve of a direct current motor type, and the fresh air introduction valve is configured by an electrically operated valve of a step motor type, and the controller delays a valve-closing start timing of the intake amount regulation valve by a predetermined period of time from a start of opening the fresh air introduction valve with expecting delay in opening of the fresh air introduction valve.

According to the above configuration (9), in addition to the operation of the above (2), the controller delays the valve-closing start timing of the intake amount regulation valve by the predetermined period of time from the start of opening the fresh air introduction valve with expecting delay in opening of the fresh air introduction valve with low responsivity. Accordingly, when the engine decelerates, even if introduction of the fresh air to the intake passage is delayed, the deficient amount of the intake air is compensated for by the delay in decrease in the intake air.

(10) To achieve the above object, in the above configuration (2), preferably, the intake amount regulation valve is configured by an electrically operated valve of a direct current motor type, and the fresh air introduction valve is configured by an electrically operated valve of a step motor type, and the controller periodically obtains an actual opening degree of the fresh air introduction valve at each time when the controller controls the fresh air introduction valve to open with expecting delay in opening of the fresh air introduction valve, calculates the intake opening degree corresponding to the obtained actual opening degree, and controls the intake amount regulation valve to close to the calculated intake opening degree.

According to the above configuration (10), in addition to the operation of the above (2), the controller controls the intake amount regulation valve to close to the intake opening degree corresponding to the change in the actual opening degree of the fresh air introduction valve during valve-opening control of the fresh air introduction valve with expecting delay in valve-opening of the fresh air introduction valve with low responsivity. Accordingly, when the engine decelerates, even if the introduction of the fresh air to the intake passage is delayed, the deficient amount of the fresh air is compensated for by the intake air that is regulated according to the actual opening degree of the fresh air introduction valve.

### Effects of the Invention

According to the above configuration (1), both the intake amount regulation valve and the fresh air introduction valve are used during deceleration of the engine, and thus misfire of the engine due to the influence of the remaining exhaust gas recirculation gas can be appropriately prevented.

According to the above configuration (2), both the intake amount regulation valve and the fresh air introduction valve are used when the engine decelerates during not-increase in pressure, and thus misfire of the engine due to the influence of the remaining exhaust gas recirculation gas can be appropriately prevented.

According to the above configuration (3), both the intake amount regulation valve and the fresh air introduction valve are used when the engine decelerates during not-increase in pressure, and thus misfire of the engine due to the influence of the remaining exhaust gas recirculation gas can be appropriately prevented.

According to the above configuration (4), in addition to the effect of the configuration (2), during not-increase in pressure, the fresh air at an appropriate amount corresponding to the operation state of the engine can be promptly introduced to the intake passage from the term of deceleration of the engine by the target fresh air opening degree map. Further, during pressure increase, backflow of the intake air to the fresh air introduction passage can be prevented, and thus during deceleration of the engine, the fresh air at an appropriate amount corresponding to the operation sate of the engine can be introduced to the intake passage after decrease to negative pressure.

According to the above configuration (5), in addition to the effect of any one of the configurations (1) to (4), the total amount of intake air introduced to the engine during deceleration can be accurately regulated to the appropriate amount.

According to the above configuration (6), in addition to the effect of any one of the configurations (1) to (5), the ratio of the remaining exhaust gas recirculation gas in the intake air can be promptly lowered, and the intake control can be gradually returned to a usual control state with maintaining stable combustion in the engine.

According to the above configuration (7), in addition to the effect of the configuration (6), the total intake amount of the intake air introduced to the engine until scavenging of the remaining exhaust recirculation gas during deceleration is completed can be regulated to the appropriate amount.

According to the above configuration (7), in addition to the effect of the configuration (5), the total intake amount of the intake air introduced to the engine during deceleration can be accurately regulated to the appropriate amount while achieving cost reduction and size reduction in the fresh air introduction valve by adopting a step motor type.

According to the above configuration (9), in addition to the effect of the configuration (2), the total intake amount of the intake air introduced to the engine during deceleration can be accurately regulated to the appropriate amount while achieving cost reduction and size reduction of the fresh air introduction valve by adopting a step motor type.

According to the above configuration (10), in addition to the effect of the configuration (2), the total intake amount of the intake air introduced to the engine during deceleration can be accurately regulated to the appropriate amount while achieving cost reduction and size reduction of the fresh air introduction valve by adopting a step motor type.

### BRIEF DESCRIPTION OF THE DRAWINGS

FIG. 1 is a schematic configurational view of a gasoline engine system in a first embodiment;

FIG. 2 is a flowchart illustrating a process of determining deceleration of an engine and heightening EGR ratio in intake air in the first embodiment;

FIG. 3 is a flowchart illustrating intake air control and fresh air introduction control performed based on determination of deceleration of the engine and others in the first embodiment;

FIG. 4 is a final opening-degree correction-value map that is referred to determine a final opening-degree correction value corresponding to a target intake amount difference in the first embodiment;

FIG. 5 is time charts illustrating behavior of various parameters in a case where the engine decelerates from a supercharging region (during increase in intake pressure) in the first embodiment;

FIG. 6 is time charts corresponding to FIG. 5, illustrating behavior of various parameters in a case where the engine decelerates from a non-supercharging region (during not-increase in the intake pressure) in the first embodiment;

FIG. 7 is a flowchart illustrating a calculation of a final target fresh-air opening degree and fresh air introduction control during operation of an engine in a second embodiment;

FIG. 8 is a target fresh-air opening degree map referred to determine a target fresh air opening degree with respect to an engine rotational speed and an intake pressure in the second embodiment;

FIG. 9 is a flowchart illustrating a process content of determining completion of scavenging remaining EGR gas during deceleration of the engine in the second embodiment;

FIG. 10 is a flowchart illustrating contents of intake-air control and fresh air introduction control performed based on determination of deceleration of the engine and others in the second embodiment;

FIG. 11 is time charts corresponding to FIG. 5, illustrating behavior of various parameters in a case where the engine decelerates from a supercharging region (during increase in the intake pressure) in the second embodiment;

FIG. 12 is time charts corresponding to FIG. 6, illustrating behavior of various parameters in a case where the engine decelerates from a non-supercharging region (during not-increase in the intake pressure) in the second embodiment;

FIG. 13 is a flowchart illustrating contents of intake-air control and fresh air introduction control performed based on determination of deceleration of an engine and others in a third embodiment;

FIG. 14 is a flowchart illustrating contents of intake-air control and fresh air introduction control performed based on determination of deceleration of an engine and others in a fourth embodiment; and

FIG. 15 is a flowchart illustrating contents of intake-air control and fresh air introduction control performed based on determination of deceleration of an engine and others in a fifth embodiment.

### MODE FOR CARRYING OUT THE INVENTION

### First Embodiment

Hereinafter, a first embodiment embodying an engine system according to an aspect of the present invention will be described in detail with reference to the drawings.

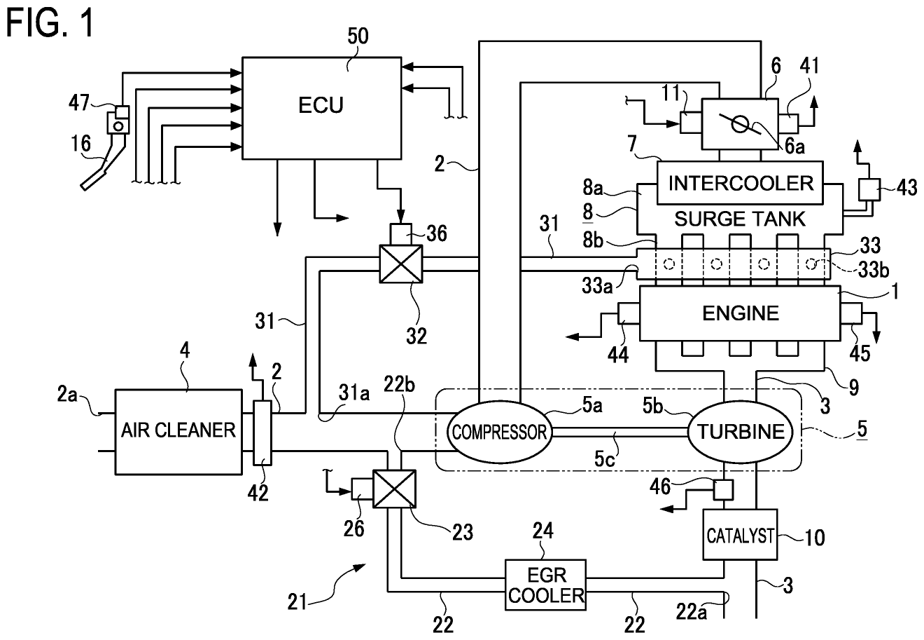

FIG. 1 is a schematic configurational view illustrating a gasoline engine system according to the present embodiment. The gasoline engine system (hereinafter, simply referred to as the “engine system”) mounted in an automobile includes an engine 1 including a plurality of cylinders. The engine 1 is a four-stroke cycle reciprocal engine with four cylinders and includes a well-known configuration such as pistons and a crank shaft. The engine 1 includes an intake passage 2 for introducing intake air to the cylinders, and an exhaust passage 3 for discharging exhaust gas from the cylinders of the engine 1. A supercharger 5 is provided in the intake passage 2 and the exhaust passage 3. In the intake passage 2, an intake inlet 2a, an air cleaner 4, a compressor 5a of the supercharger 5, an electronic throttle device 6, an intercooler 7, and an intake manifold 8 are provided in this order from an upstream side of the intake passage 2.

The electronic throttle device 6 is arranged in the intake passage 2 upstream of the intake manifold 8. The electronic throttle device 6 is opened or closed by a driver's operation of an accelerator, and thus regulates the intake amount of intake air that flows through the intake passage 2. In the present embodiment, the electronic throttle device 6 is configured by an electrically operated valve of a direct current (DC) motor type. The electronic throttle device 6 includes a throttle valve 6a opened or closed by a DC motor 11, and a throttle sensor 41 that detects an opening degree (a throttle opening degree) TA of the throttle valve 6a. The electronic throttle device 6 corresponds to an example of an intake amount regulation valve according to the present invention. The intake manifold 8 is placed directly upstream of the engine 1. The intake manifold 8 includes a surge tank 8a to which intake air is introduced, and a plurality of (four) branch pipes 8b that distribute the intake air introduced to the surge tank 8a to the cylinders of the engine 1. In the exhaust passage 3, an exhaust manifold 9, a turbine 5b of the supercharger 5, and a catalyst 10 are provided in this order from an upstream side of the exhaust passage 3. The catalyst 10 purifies exhaust gas and is configured by a three-way catalyst, for example.

The supercharger 5 is provided to increase the pressure of intake air in the intake passage 2. The supercharger 5 includes a compressor 5a placed in the intake passage 2, the turbine 5b placed in the exhaust passage 3, and a rotary shaft 5c connecting the compressor 5a to the turbine 5b to allow the compressor 5a and the turbine 5b to integrally rotate. The turbine 5b is rotated by exhaust gas flowing through the exhaust passage 3, and the compressor 5a is rotated in association with this rotation of the turbine 5b, and thus the pressure of intake air flowing through the intake passage 2 is increased. The intercooler 7 cools the intake air whose pressure has been increased by the compressor 5a.

The engine 1 is provided with a fuel injection unit (not illustrated) in each of the cylinders to inject fuel. The fuel injection unit injects fuel into the corresponding cylinder of the engine 1, the fuel being supplied from a fuel supply device (not illustrated). In each of the cylinders, a combustible air-fuel mixture is made of the fuel injected from the fuel injection unit and the intake air introduced from the intake manifold 8.

The engine 1 is also provided with an ignition device (not illustrated) corresponding to each of the cylinders. The ignition device is configured to ignite the combustible air-fuel mixture made in the cylinders. The combustible air-fuel mixture in each of the cylinders is ignited by the ignition device, and then explodes and combusts. Exhaust gas after the combustion is discharged to outside from each of the cylinders through the exhaust manifold 9, the turbine 5b, and the catalyst 10. At that time, a piston (not illustrated) moves up and down in each of the cylinders, and thus a crank shaft (not illustrated) rotates to generate power of the engine 1.

The engine system according to the present embodiment is provided with an exhaust gas recirculation device (EGR device) 21 of a low-pressure loop type. The EGR device 21 includes an exhaust gas recirculation passage (EGR passage) 22 that allows exhaust gas recirculation gas (EGR gas) as a part of exhaust gas discharged to the exhaust passage 3 from the cylinders to recirculate into the cylinders of the engine 1 through the intake passage 2.

The EGR device 21 also includes an exhaust gas recirculation valve (EGR valve) 23 that regulates flow rate of the EGR gas in the EGR passage 22. The EGR passage 22 includes an inlet 22a and an outlet 22b. The inlet 22a of the EGR passage 22 is connected to the exhaust passage 3 downstream of the catalyst 10. The outlet 22b of the EGR passage 22 is connected to the intake passage 2 upstream of the compressor 5a. The EGR passage 22 is also provided with an EGR cooler 24 placed upstream of the EGR valve 23 to cool down the EGR gas.

In the present embodiment, the EGR valve 23 is configured by an electrically operated valve of a DC motor type and includes a valve element (not illustrated) whose opening degree is varied by a DC motor 26. Preferably, the EGR valve 23 has properties such as large flow rate, high responsivity, and high precision. For example, a “double eccentric valve” described in JP 5759646 B2 may be used as a structure of the EGR valve 23 in the present embodiment. The double eccentric valve is configured to control a large flow rate.

In the engine system, the EGR valve 23 is opened in a supercharging region (a zone where an intake amount is relatively large) in which the supercharger 5 is operated. Thus, a part of exhaust gas flowing through the exhaust passage 3 flows into the EGR passage 22 from the inlet 22a as EGR gas. This EGR gas further flows through the EGR cooler 24 and the EGR valve 23 to the intake passage 2, and recirculates through the cylinders of the engine 1 via the compressor 5a, the electronic throttle device 6, the intercooler 7, and the intake manifold 8.

In the present embodiment, the intake passage 2 is provided with a fresh air introduction passage 31 introducing fresh air to the intake passage 2 downstream of the electronic throttle device 6. The fresh air introduction passage 31 includes an inlet 31a connected to the intake passage 2 upstream of the outlet 22b of the EGR passage 22. The fresh air introduction passage 31 is also provided with a fresh air introduction valve 32 for regulating the fresh air introduction amount of fresh air introduced to the intake passage 2 from the fresh air introduction passage 31. In the present embodiment, the fresh air introduction valve 32 is configured by a electrically operated valve of a step motor type, and includes a valve element (not illustrated) whose opening degree is varied by a step motor 36. The fresh air introduction passage 31 is provided with a fresh air distribution pipe 33 on an outlet side to distribute fresh air to each of the branch pipes 8b of the intake manifold 8. That is, the outlet side of the fresh air introduction passage 31 is connected to the intake passage 2 (intake manifold 8) downstream of the electronic throttle device 6 via the fresh air distribution pipe 33. The fresh air distribution pipe 33 is a long pipe and is attached to the intake manifold 8 by crossing over the plurality of branch pipes 8b. The fresh air distribution pipe 33 includes one fresh air inlet 33a in which fresh air is introduced and a plurality of fresh air outlets 33b provided corresponding to the plurality of branch pipes 8b, respectively. The fresh air outlets 33b communicate with inside of the corresponding branch pipes 8b. The fresh air inlet 33a is formed at an end of the fresh air distribution pipe 33 in a longitudinal direction, and an outlet side of the fresh air introduction passage 31 is connected to the fresh air inlet 33a.

Motor-operated valves of a DC motor type generally have high responsivity but cost much and tend to have a large size. On the other hand, electrically operated valves of a step motor type have lower responsivity than the electrically operated valves of DC motor types, but electrically operated valve achieve low cost and small size. In the present embodiment, the electronic throttle device 6 adopts an electrically operated valve of a DC motor type because the electronic throttle device 6 functions in direct response to operation of the engine 1 and needs high responsivity. It is preferable to adopt a DC motor type for the fresh air introduction valve 32 for quick response, but a step motor type is adopted to prioritize cost reduction and size reduction.

As shown in FIG. 1, various sensors 41 to 47 provided in this engine system correspond to one example of an operation state detecting unit of the present invention to detect the operation state of the engine 1. An air flow meter 42 provided near the air cleaner 4 detects an intake amount Ga of intake air flowing from the air cleaner 4 to the intake passage 2 and outputs an electric signal according to a detected value. An intake pressure sensor 43 provided in the surge tank 8a detects an intake pressure PM on a downstream side of the electronic throttle device 6 and outputs an electric signal according to a detected value. A water temperature sensor 44 provided in the engine 1 detects a temperature (cooling water temperature) THW of cooling water flowing inside the engine 1 and outputs an electric signal according to a detected value. A rotation speed sensor 45 provided in the engine 1 detects rotational speed of the crank shaft as a rotational speed (engine rotational speed) NE of the engine 1 and outputs an electric signal according to a detected value. An oxygen sensor 46 provided in the exhaust passage 3 detects oxygen concentration (output voltage) Ox in exhaust gas, which has been discharged out to the exhaust passage 3, and outputs an electric signal according to a detected value. An accelerator pedal 16 provided in a driver's seat is provided with an accelerator sensor 47. The accelerator sensor 47 detects a pressed angle of the accelerator pedal 16 as an accelerator opening degree ACC and outputs an electric signal according to a detected value.

The engine system includes an electronic control unit (ECU) 50 taking in charge of various controls. The various sensors 41 to 47 are each connected to the ECU 50. Further, the DC motor 11 of the electronic throttle device 6, the DC motor 26 of the EGR valve 23, and the step motor 36 of the fresh air introduction valve 32 and others are each connected to the ECU 50.

The ECU 50 inputs the various signals output from the various sensors 41 to 47 and controls injectors and ignition coils to perform the fuel injection control and the ignition timing control based on the input signals in the present embodiment. Further, the ECU 50 also controls the electronic throttle device 6, the EGR valve 23, and the fresh air introduction valve 32 (the DC motors 11 and 26, and the step motor 36) to perform intake-air control, EGR control, and fresh air introduction control based on the various signals.

In the intake-air control, the electronic throttle device 6 is controlled based on a detected value of the accelerator sensor 47 corresponding to operation of the accelerator pedal 16 operated by a driver, and thus the intake amount of intake air introduced to the engine 1 is controlled. When the engine 1 decelerates, the ECU 50 controls the electronic throttle device 6 to close to a position closer to a closed position to decrease intake air. In the EGR control, the EGR valve 23 is controlled according to the operation state of the engine 1, and thus flow rate of EGR gas recirculating the engine 1 is controlled. When the engine 1 decelerates, the ECU 50 controls the EGR valve 23 to be fully closed to shut off EGR gas flowing to the engine 1 (EGR cut). In the fresh air introduction control, the fresh air introduction valve 32 is controlled according to the operation state of the engine 1, and thus the fresh air introduction amount of fresh air introduced downstream of the electronic throttle device 6 is controlled.

As well known, the ECU 50 includes a central processing unit (CPU), various memories, an external input circuit, and an external output circuit. The memories store predetermined control program related to various control on the engine 1. Based on detected values of the various sensors 41 to 47 input through the input circuit to the CPU, the CPU performs the various control described above based on the predetermined control program. In the present embodiment, the ECU 50 corresponds to an example of a controller of the present invention.

Herein, to decrease a flow rate of EGR gas associated with deceleration of the engine 1, the engine system is configured to control the EGR valve 23 to close. However, decrease in the EGR gas flow rate could be delayed even if the EGR valve 23 is controlled to close during deceleration of the engine 1 since the EGR device 21 is a low-pressure loop type. This may cause misfire of the engine 1 due to influence of the EGR gas remaining in the intake passage 2. To address this, the engine system performs various controls described below in order to avoid or prevent misfire on deceleration of the engine 1.

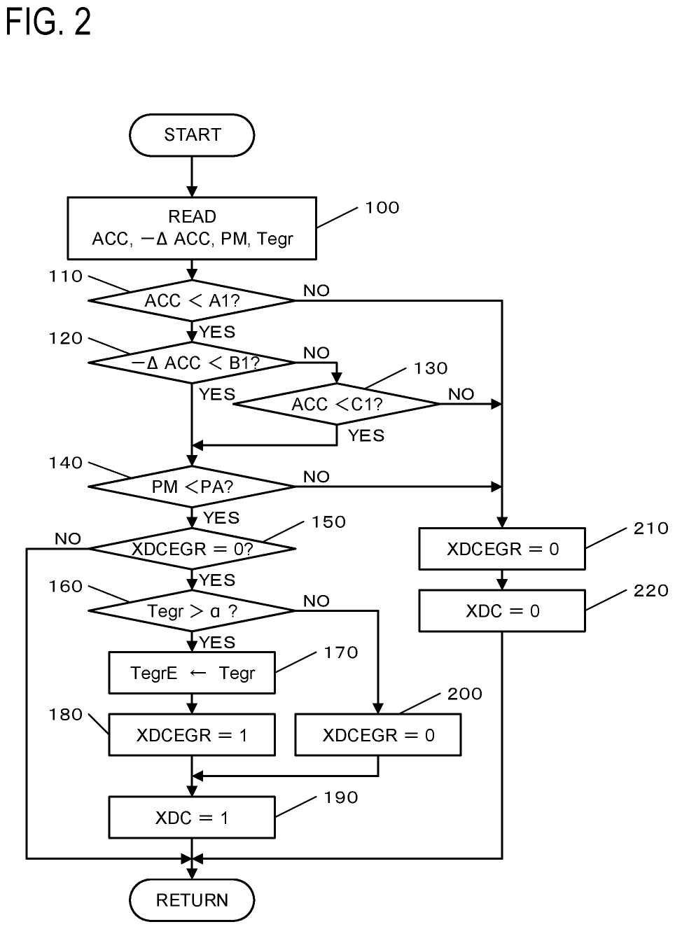

FIG. 2 is a flowchart illustrating a process of determining deceleration of the engine 1 and heightening in EGR ratio relative to intake air (increase in ratio of EGR gas contained in intake air).

When a process proceeds to this routine, the ECU 50 reads (an accelerator opening degree ACC and an accelerator valve-closing speed −ΔACC based on a detected value of the accelerator sensor 47 in step 100. The ECU 50 also reads an intake pressure PM based on a detected value of the intake-air pressure sensor 43 and reads a current EGR ratio Tegr. The accelerator valve-closing speed −ΔACC represents decreased speed of the accelerator opening degree ACC when the accelerator pedal 16 has been stepped off. The ECU 50 determines the accelerator valve-closing speed −ΔACC by subtracting a previous accelerator opening degree ACC from the current accelerator opening degree ACC. Further, the ECU 50 obtains an EGR ratio Tegr based on an intake amount Ga and an engine rotational speed NE that are currently detected by referring to a predetermined map.

Next, in step 110, the ECU 50 determines whether the accelerator opening degree ACC is smaller than a predetermined value A1. For example, “20%” relative to a fully open position (100%) may be used as the predetermined value A1. The ECU 50 shifts the process to step 120 when the determination result is affirmative since the accelerator opening degree ACC is relatively small. Alternatively, the ECU 50 shifts the process to step 210 when the determination result is negative since the accelerator opening degree ACC is relatively large.

In step 120, the ECU 50 determines whether the accelerator valve-closing speed −ΔACC is smaller than a predetermined value B1. For example, “−3%/4 ms” may be used as the predetermined value B1. The ECU 50 shifts the process to step 130 when the determination result is negative since the accelerator valve-closing speed −ΔACC is relatively slow. Alternatively, the ECU 50 shifts the process to step 140 when the determination result is affirmative since the accelerator valve-closing speed −ΔACC is relatively fast.

In step 130, the ECU 50 determines whether the accelerator opening degree ACC is smaller than a predetermined value C1 (<A1). For example, “5%” may be used as the predetermined value C1. The ECU 50 shifts the process to step 140 when the determination result is affirmative since the accelerator opening degree ACC is very small. Alternatively, the ECU 50 shifts the process to step 210 when the determination result is negative.

When the process proceeds to step 140 from step 120 or step 130, the ECU 50 determines that the engine 1 decelerates. In step 140, the ECU 50 determines whether an intake pressure PM is lower than an atmospheric pressure PA. In other words, the ECU 50 determines whether the intake pressure PM is negative. The ECU 50 shifts the process to step 150 when the determination result is affirmative since the engine 1 decelerates from a non-supercharging region in which the supercharger 5 does not increase pressure of intake air to positive pressure (a term of not-increase in the intake pressure). Alternatively, the ECU 50 shifts the process to step 210 when the determination result is negative since the engine 1 decelerates from a supercharging region in which the supercharger 5 increases pressure of intake air to positive pressure (a term of increase in the intake pressure).

In step 150, the ECU 50 determines whether a deceleration EGR flag XDCEGR is “0”. As described later, the flag XDCEGR is set to “1” when the ECU 50 determines that

EGR gas remains in the intake passage 2 after the EGR valve 23 is controlled to fully close during deceleration. Alternatively, the flag XDCEGR is set to “0” when the above condition is not applied. The ECU 50 shifts the process to step 160 when the determination result is affirmative since the ECU 50 determines that the EGR gas does not remain in the intake passage 2 during deceleration. Alternatively, the ECU 50 returns the process to step 100 when the determination result is negative since the ECU 50 determines that the EGR gas remains in the intake passage 2 during deceleration.

In step 160, the ECU 50 determines whether a currently read EGR ratio Tegr is larger than a predetermined value α. For example, “5%” may be used as the predetermined value α. The ECU 50 shifts the process to step 170 when the determination result is affirmative since EGR has been performed at a start of deceleration. Alternatively, the ECU 50 shifts the process to step 200 when the determination result is negative since the EGR valve 23 is fully closed and thus EGR cut is performed at the start of deceleration.

In step 170, the ECU 50 sets an EGR ratio Tegr at the start of deceleration to a deceleration EGR ratio TegrE.

Next, in step 180, the ECU 50 determines that the EGR gas remains in the intake passage 2 during deceleration, and thus sets the deceleration EGR flag XDCEGR to “1”.

In step 190, the ECU 50 sets a deceleration flag XDC to “1” since the engine 1 decelerates and returns the process to step 100.

On the other hand, when the process proceeds to step 200 from step 160, the ECU 50 determines that there is no remaining EGR gas during deceleration and thus sets the deceleration EGR flag XDCEGR to “0” and shifts the process to step 190.

When the process proceeds to step 210 from step 110, step 130, or step 140, the ECU 50 determines that there is no remaining EGR gas during deceleration and thus sets the deceleration EGR flag XDCEGR to “0”.

Next, in step 220, the ECU 50 sets a deceleration flag XDC to “0” since the engine 1 does not decelerate and returns the process to step 100.

According to the above control, the ECU 50 determines whether the engine 1 decelerates based on the accelerator opening degree ACC and the accelerator valve-closing speed −ΔACC. Herein, valve-closing of the electronic throttle device 6 leads to deceleration of the engine 1. Since the electronic throttle device 6 is controlled according to the accelerator opening degree ACC, determining deceleration of the engine 1 according to the accelerator opening degree ACC leads to quick determination of deceleration. In step 140, it is determined whether the intake pressure PM is negative (during not-increase in pressure) or positive (during increase in pressure) so as to prevent backflow to the fresh air introduction passage 31 which may be caused by valve-opening of the fresh air introduction valve 32 at the positive pressure (during increase in pressure).

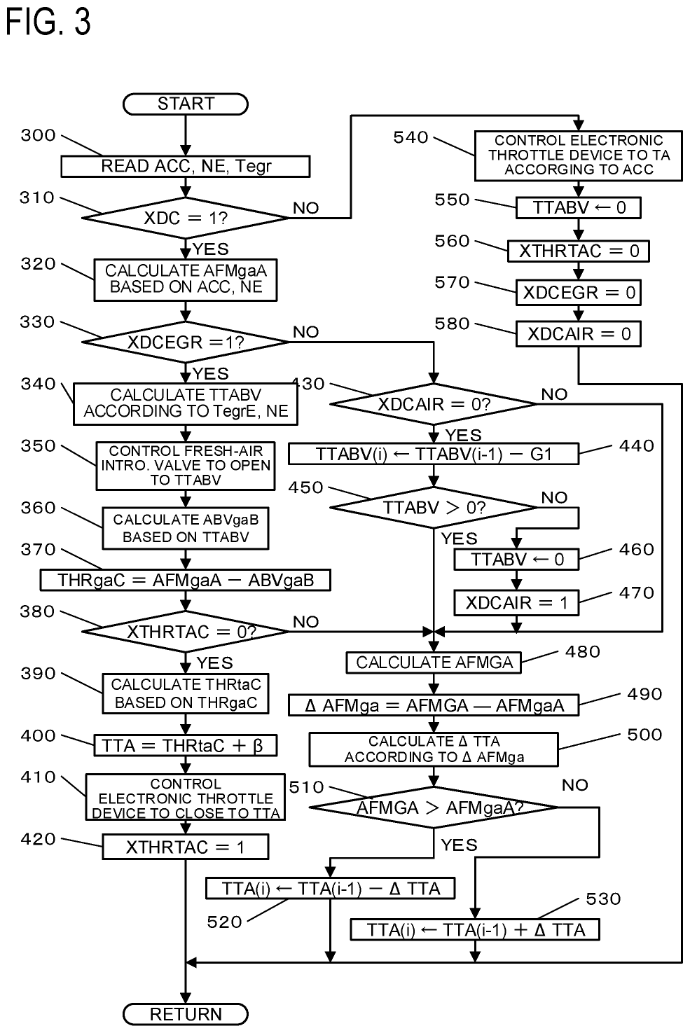

Next, intake air control and fresh air introduction control that are performed based on the above-mentioned determination of deceleration of the engine 1 and others will be described. FIG. 3 is a flowchart illustrating the contents of the intake air control and the fresh air introduction control.

When a process proceeds to this routine, the ECU 50 reads the accelerator opening degree ACC and the engine rotational speed NE based on detected values of the accelerator sensor 47 and the rotation speed sensor 45 in step 300. The ECU 50 also reads a deceleration EGR ratio TegrE at a start of deceleration which is stored in a memory.

Next, in step 310, the ECU 50 determines whether a deceleration flag XDC is “1”. The ECU 50 shifts the process to step 320 when the determination result is affirmative since the engine 1 decelerates from a term of not-increase in pressure. Alternatively, the ECU 50 shifts the process to step 540 when the determination result is negative since the engine 1 does not decelerate.

In step 320, the ECU 50 calculates a target intake amount AFMgaA based on the read accelerator opening degree ACC and the read engine rotational speed NE. The ECU 50 obtains the target intake amount AFMgaA corresponding to the accelerator opening degree ACC and the engine rotational speed NE by referring to a predetermined target intake amount map (not shown).

Next, in step 330, the ECU 50 determines whether the deceleration EGR flag XDCEGR is “1”. The ECU 50 shifts the process to step 340 when the determination result is affirmative since EGR gas remains in the intake passage 2 during deceleration. Alternatively, the ECU 50 shifts the process to step 430 when the determination result is negative since the EGR gas does not remain in the intake passage 2 during deceleration.

In step 340, the ECU 50 calculates a final target opening degree (a final target fresh-air opening degree) TTABV of the fresh air introduction valve 32 that corresponds to the read deceleration EGR ratio TegrE and the read engine rotational speed NE at the start of deceleration. The ECU 50 obtains the final target fresh-air opening degree TTABV corresponding to the deceleration EGR ratio TegrE and the engine rotational speed NE at the start of deceleration by referring to a predetermined final target fresh-air opening degree map (not shown). In the final target fresh-air opening degree map of the present embodiment, the final target fresh-air opening degree TTABV is set to a fully closed position when an operation state of the engine 1 is other than deceleration.

Next, in step 350, the ECU 50 controls the fresh air introduction valve 32 to open from a fully closed position to the final target fresh-air opening degree TTABV.

Next, in step 360, the ECU 50 calculates a fresh-air introduction amount ABVgaB based on the final target fresh-air opening degree TTABV. The ECU 50 obtains the fresh-air introduction amount ABVgaB corresponding to the final target fresh-air opening degree TTABV by referring to a predetermined fresh-air introduction amount map (not shown).

Next, in step 370, the ECU 50 calculates a target intake amount (target passing intake amount) THRgaC of the intake air passing through the throttle valve 6a by subtracting the fresh-air introduction amount ABVgaB from the target intake amount AFMgaA.

Next, in step 380, the ECU 50 determines whether a throttle closing start flag XTHRTAC is “0”. As described later, this flag XTHRTAC is set to “1” when closing of the throttle valve 6a has been started. Alternatively, the flag XTHRTAC is set to “0” when closing of the throttle valve 6a has not yet been started. The ECU 50 shifts the process to step 390 when the determination result is affirmative since closing of the throttle valve 6a has not yet been started. Alternatively, the ECU 50 shifts the process to step 480 when the determination result is negative since closing of the throttle valve 6a has been started.

In step 390, the ECU 50 calculates a target throttle opening degree THRtaC based on the calculated target passing intake amount THRgaC. The ECU 50 obtains the target throttle opening degree THRtaC corresponding to the target passing intake amount THRgaC by referring to a predetermined target throttle opening degree map (not shown).

Next, in step 400, the ECU 50 calculates a final target throttle opening degree TTA by adding a predetermined value β to the target throttle opening degree THRtaC. That is, the ECU 50 increases the calculated target throttle opening degree THRtaC by the predetermined value β with expecting delay in valve opening of the fresh air introduction valve 32 since the valve 32 is of a step motor type.

Next, in step 410, the ECU 50 controls the electronic throttle device 6 (throttle valve 6a) to close to the final target throttle opening degree TTA.

Then, in step 420, the ECU 50 sets a throttle closing start flag XTHRTAC to “1” and returns the process to step 300.

On the other hand, when the process proceeds to step 430 from step 330, the ECU 50 determines whether a deceleration intake flag XDCAIR is “0” since EGR gas does not remain in the intake passage 2 during deceleration. As described later, this flag XDCAIR is set to “1” when closing of the fresh air introduction valve 32 is completed after EGR gas remaining in the intake passage 2 during deceleration has been scavenged. Alternatively, the flag XDCAIR is set to “0” when closing of the fresh air introduction valve 32 is not completed after EGR gas remaining in the intake passage 2 during deceleration has been scavenged. The ECU 50 shifts the process to step 440 when the determination result is affirmative since closing of the fresh air introduction valve 32 is not completed. Alternatively, the ECU 50 shifts the process to step 480 when the determination result is negative since closing of the fresh air introduction valve 32 is completed.

In step 440, the ECU 50 calculates a current final target fresh-air opening degree TTABV(i) of by subtracting a predetermined value G1 from a previous final target fresh-air opening degree TTABV(i-1). Based on the current final target fresh-air opening degree TTABV(i), the ECU 50 controls the fresh air introduction valve 32 to be gradually closed.

For example, “two steps” (a control amount of the step motor 36) may be applied to the predetermined value G1. By repetition of the process in step 440, an opening degree of the fresh air introduction valve 32 is gradually decreased.

Next, in step 450, the ECU 50 determines whether the final target fresh-air opening degree TTABV is larger than “0”. That is, the ECU 50 determines whether the fresh air introduction valve 32 is open. The ECU 50 shifts the process to step 480 when the determination result is affirmative. Alternatively, the ECU 50 shifts the process to step 460 when the determination result is negative.

In step 460, the ECU 50 sets the final target fresh-air opening degree TTABV to “0”. Next, in step 470, the ECU 50 sets the deceleration intake flag XDCAIR to “1” and shifts the process to step 480.

When the process proceeds to step 480 from step 380, step 430, step 450, or step 470, the ECU 50 calculates an intake amount (an air-flow-meter passing intake amount) AFMGA of intake air passing through the air flow meter 42. The ECU 50 performs the calculation based on an intake amount Ga detected by the air flow meter 42.

Next, in step 490, the ECU 50 calculates a target intake amount difference ΔAFMga by subtracting the target intake amount AFMgaA from the air-flow-meter passing intake amount AFMGA.

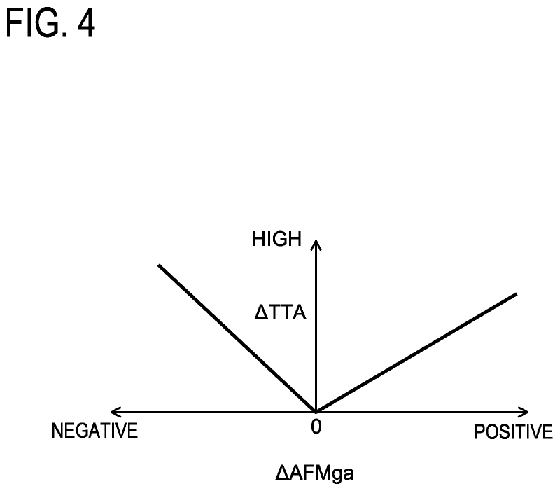

Next, in step 500, the ECU 50 calculates a correction value (final opening-degree correction value) ΔTTA of the final target throttle opening degree TTA corresponding to the calculated target intake amount difference ΔAFMga. For example, the ECU 50 obtains the final opening-degree correction value ΔTTA corresponding to the target intake amount difference ΔAFMga by referring to a final opening-degree correction value map illustrated in FIG. 4. In the map, the final opening-degree correction value ΔTTA is made to increase in direct proportion to an upper limit value relative to the absolute value of the target intake amount difference ΔAFMga.

Next, in step 510, the ECU 50 determines whether the air-flow-meter passing intake amount AFMGA is larger than the target intake amount AFMgaA. The ECU 50 shifts the process to step 520 when the determination result is affirmative since the throttle valve 6a is requested to be closed. Alternatively, the ECU 50 shifts the process to step 530 when the determination result is negative since the throttle valve 6a is requested to be opened.

Then, in step 520, the ECU 50 calculates a current final target throttle opening degree TTA(i) by subtracting the final opening-degree correction value ATTA from a previous final target throttle opening degree TTA(i-1). Based on the current final target throttle opening degree TTA(i), the ECU 50 controls the electronic throttle device 6 to close and returns the process to step 300. By repetition of the process in step 520, an opening degree of the electronic throttle device 6 (throttle valve 6a) is gradually decreased.

Alternatively, in step 530, the ECU 50 calculates a current final target throttle opening degree TTA(i) by adding the final opening degree correction value ΔTTA to a previous final target throttle opening degree TTA(i-1). Based on the current final target throttle opening degree TTA(i), the ECU 50 controls the electronic throttle device 6 to open and returns the process to step 300. By repetition of the process in step 530, an opening degree of the electronic throttle device 6 (throttle valve 6a) is gradually increased.

On the other hand, in step 540 shifted from step 310, the engine 1 does not decelerate, and thus the ECU 50 controls the electronic throttle device 6 to open by a throttle opening degree TA corresponding to the accelerator opening degree ACC so that the usual intake control is performed. The ECU 50 obtains the throttle opening degree TA corresponding to the accelerator opening degree ACC by referring to a throttle opening degree map (not shown).

Next, in step 550, the ECU 50 sets the final target fresh-air opening degree TTABV to “0”. Then, in step 560, the ECU 50 sets a throttle closing start flag XTHRTAC to “0”.

Next, in step 570, the ECU 50 sets the deceleration EGR flag XDCEGR to “0”. Further, in step 580, the ECU 50 sets the deceleration intake flag XDCAIR to “0” and returns the process to step 300.

According to the above control, when the ECU 50 determines deceleration of the engine 1, the ECU 50 controls the EGR valve 23 to fully close, controls the fresh air introduction valve 32 to open to a predetermined fresh-air opening degree (final target fresh-air opening degree TTABV), and controls the electronic throttle device 6 to close to a predetermined intake opening degree (final target throttle opening degree TTA). More specifically, when the ECU 50 determines deceleration of the engine 1 during not-increase in the intake pressure, the ECU 50 controls the EGR valve 23 to fully close, the fresh air introduction valve 32 to open to a predetermined fresh-air opening degree (final target fresh-air opening degree TTABV) from a fully closed position, and after a start of valve-opening control of the fresh air introduction valve 32, controls the electronic throttle device 6 to close to a predetermined intake opening degree (final target throttle opening degree TTA). Consequently, a total intake amount of intake air introduced to the engine 1 is regulated. That is, after the ECU 50 determines deceleration of the engine 1, without determining misfire of the engine 1, the ECU 50 controls the fresh air introduction valve 32 to open and then controls the throttle valve 6a to close to a degree corresponding to an increased intake amount increased by introduction of fresh air. Accordingly, delay in response of the fresh air introduction valve 32 due to a step motor type is compensated for, and thus delay in introduction of fresh air to the intake passage 2 is prevented.

According to the above control, the ECU 50 calculates a target intake amount AFMgaA of the engine 1 corresponding to the accelerator opening degree ACC and the engine rotational speed NA that are detected at the start of deceleration of the engine 1. Further, the ECU 50 calculates the fresh-air introduction amount ABVgaB corresponding to a predetermined fresh-air opening degree (final target fresh-air opening degree TTABV). Further, the ECU 50 calculates a passing intake amount (target passing intake amount THRgaC) of the intake air passing through the electronic throttle device 6 by subtracting the fresh-air introduction amount ABVgaB from the target intake amount AFMgaA, and further calculates a predetermined intake opening degree (target throttle opening degree THRtaC, final target throttle opening degree TTA) based on the passing intake amount.

According to the above control, as fresh air introduced to the intake passage 2 from the fresh air introduction passage 31 decreases a ratio of EGR gas remaining in the intake passage 2, the ECU 50 gradually decreases an opening degree of the fresh air introduction valve 32 from a predetermined fresh-air opening degree (final target fresh-air opening degree TTABV) and gradually increases an opening degree of the electronic throttle device 6 according to the gradual decrease in the opening degree of the fresh air introduction valve 32.

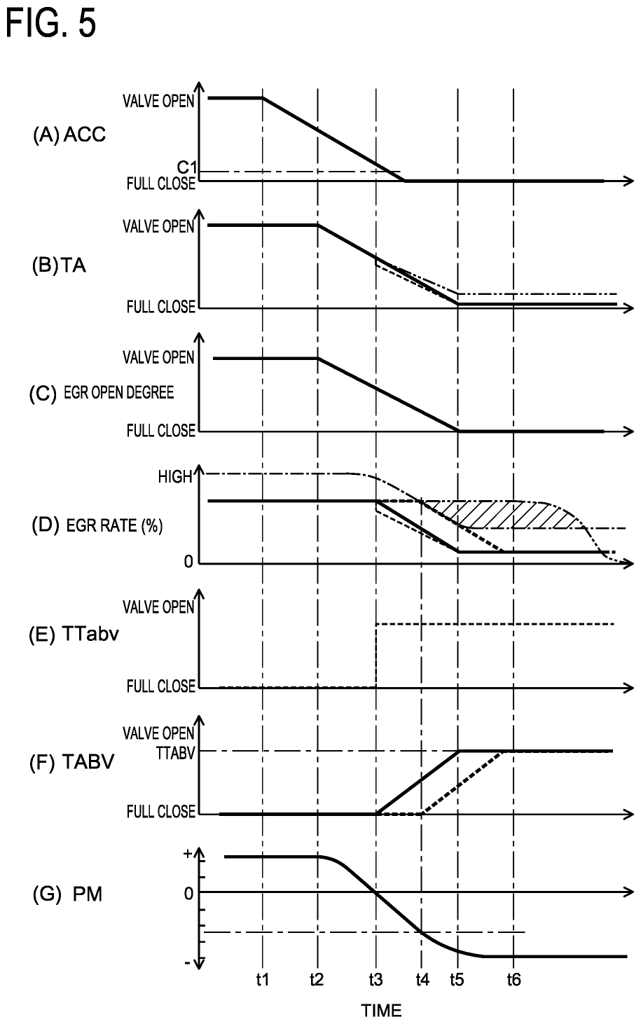

Herein, examples of behavior of various parameters related to the above control is described. FIG. 5 illustrates time charts in a case where the engine 1 decelerates from a supercharging region (during increase in intake pressure) in the present embodiment. Specifically, in FIG. 5, (A) illustrates the behavior of the accelerator opening degree ACC, (B) illustrates the behavior of the throttle opening degree TA, (C) illustrates the behavior of an opening degree of the EGR valve 23 (EGR opening degree), (D) illustrates the behavior of an EGR ratio, (E) illustrates the behavior of a target fresh-air opening degree TTabv, (F) illustrates the behavior of the actual opening degree (actual fresh-air opening degree) TABV of the fresh air introduction valve 32, and (G) illustrates the behavior of the intake pressure PM. In FIGS. 5(A) to (G), bold lines represent the behavior of the various parameters of the present embodiment. In FIG. 5(B), a chain double-dashed line represents variation in the throttle opening degree TA in a case where fresh air is not introduced to the intake passage 2 from the fresh air introduction passage 31. A broken line represents variation in the throttle opening degree TA in a case where the fresh air introduction valve 32 is controlled to open by a target fresh-air opening degree TTabv from a time t3. In FIG. 5(D), a chain double-dashed line represents variation in the EGR ratio in a case where fresh air is not introduced to the intake passage 2 from the fresh air introduction passage 31. A broken line represents variation in EGR ratio in a case where the fresh air introduction valve 32 is controlled to open by the target fresh-air opening degree TTabv from the time t3. A chain dotted line represents variation in the EGR ratio corresponding to an allowable limit for misfire. A bold broken line represents variation in EGR ratio of a conventional example that determines misfire on deceleration. A broken line in FIG. 5(E) represents a case where the fresh air introduction valve 32 is immediately opened to a predetermined target fresh-air opening degree TTabv at the time t3. An example of method of calculating the target fresh-air opening degree TTabv will be described later (see a second embodiment). A bold broken line in FIG. 5(F) represents variation in actual fresh-air opening degree TABV of a conventional example that determines misfire on deceleration. In FIGS. 5(D) and 5(F), a bold line and a bold broken line has same values in a portion where the bold line and the bold dashed line overlap each other.

As illustrated in FIG. 5(A), the accelerator opening degree ACC starts to decrease at a time t1 in a supercharging region. Then, as represented by a bold line in FIG. 5(B), the throttle opening degree TA starts to decrease from a time t2 that is slightly delayed from the time t1 (the throttle valve 6a starts to be closed). According to this, as illustrated in FIG. 5(G), the intake pressure PM starts to decrease from a positive pressure, namely, the engine 1 starts to decelerate.

Then, when it is determined at the time t3 that EGR gas remains in the intake passage 2 during deceleration of the engine 1 (XDCEGR=1), the actual fresh-air opening degree TABV starts to increase to the final target fresh-air opening degree TTABV (the fresh air introduction valve 32 starts to open) as represented by a bold line in FIG. 5(F). The EGR ratio starts to decrease accordingly as represented by a bold line in FIG. 5(D).

As represented by a bold line in FIG. 5(B), the throttle opening degree TA decreases (the throttle valve 6a is closed) from the time t3 to the time t5. As represented by a bold line in FIG. 5(F), the actual fresh-air opening degree TABV increases to the final target fresh-air opening degree TTABV in association with the decrease in the throttle opening degree TA. Further, as represented by a bold line in FIG. 5(C), the EGR opening degree decreases to a fully closed position. Further, as represented by a bold line in FIG. 5(D), the EGR ratio decreases to a minimum value.

As represented by a chain double-dotted line in FIG. 5(D), when fresh air is not introduced to the intake passage 2, the EGR ratio exceeds the allowable limit for misfire at a time t4, thus resulting in misfire on deceleration in a hatched region. On the contrary, in the present embodiment represented by a bold line or the conventional example by a bold broken line, fresh air is introduced to the intake passage 2 from the time t3 or time 4, so that the EGR ratio is below the allowable limit for misfire, thus preventing misfire on deceleration.

The present embodiment and the conventional example are compared in FIGS. 5(D) and 5(F). In the present embodiment, the fresh air introduction valve 32 starts to open at the time t3 based on determination only of deceleration, and accordingly, the EGR ratio starts to decrease. Accordingly, the EGR ratio decreases in the present embodiment earlier than the conventional example in which the fresh air introduction valve 32 starts to open at the time t4 by determination of misfire on deceleration, and thus the present embodiment can achieve prevention of misfire on deceleration from an early stage of deceleration.

On the other hand, when the fresh air introduction valve 32 is immediately opened to the target fresh-air opening degree TTabv at the time t3 as illustrated in FIG. 5(E), the throttle opening degree TA decreases once at the time t3 as represented by a broken line in FIG. 5(B), and the EGR ratio decreases once at the time t3 as represented by a broken line in FIG. 5(D). This sudden decrease may cause a torque shock in the engine 1. In the present embodiment, however, after the deceleration is determined, the fresh air introduction valve 32 is gradually opened to the final target fresh-air opening degree TTABV, the throttle opening degree TA is gradually closed, and the EGR ratio gradually decreases. Therefore, no torque shock occurs in the engine 1.

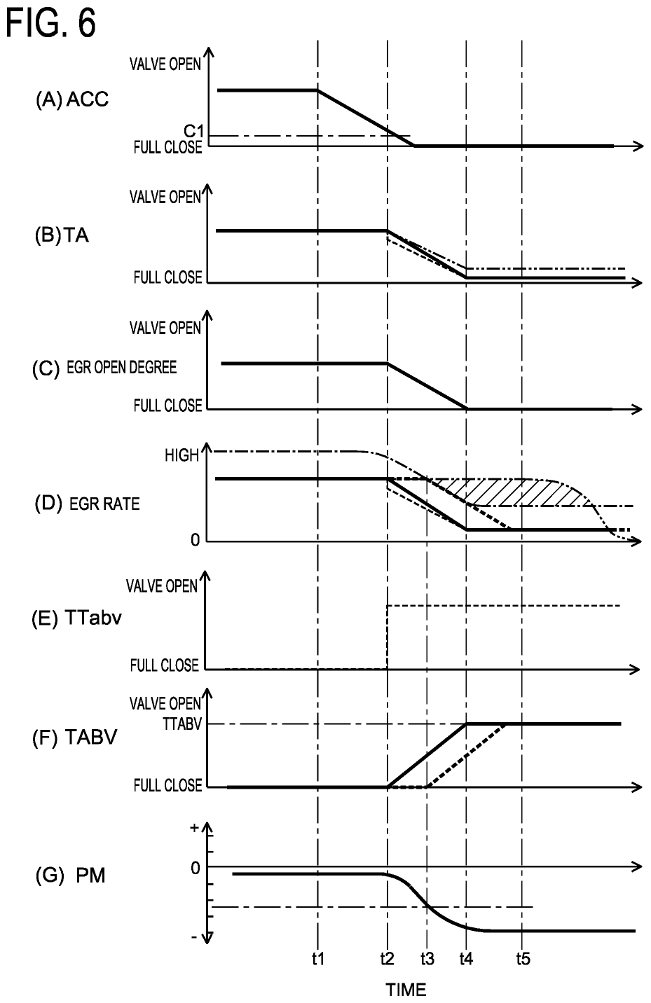

FIG. 6 is time charts corresponding to the time charts in FIG. 5 and illustrates the behavior of various parameters in a case where the engine 1 decelerates from a non-supercharging region (during not-increase in the intake air). As indicated in FIG. 6(A) to (C) and (G), each of the accelerator opening degree ACC, the throttle opening degree TA, the EGR ratio, and the intake pressure PM at a time t1 in the non-supercharging region is lower than each of the accelerator opening degree ACC, the throttle opening degree TA, the EGR ratio, and the intake pressure PM at a time t1 in the supercharging region in FIG. 5, but in view of prevention of misfire on deceleration, the similar effect to the case of the supercharging region can be achieved.

According to the configuration of the engine system of the present embodiment described above, the ECU 50 controls the EGR valve 23 to fully close when the ECU 50 determines deceleration of the engine 1 based on the accelerator opening degree ACC and an accelerator closing speed −ΔACC detected by the accelerator sensor 47. At that time, EGR gas having entered the intake passage 2 before the EGR valve 23 is controlled to fully close may remain in the intake passage 2, and when a ratio of EGR gas remaining in the intake passage 2 is high, the EGR gas may cause misfire of the engine 1 due to the EGR gas introduced with the intake air to the engine 1. To address this, according to the configuration of the present embodiment, when the ECU 50 determines deceleration of the engine 1 during not-increase in pressure, without determining misfire of the engine 1, the ECU 50 controls the fresh air introduction valve 32 to open from a fully-closed position to a final target fresh-air opening degree TTABV, and after a start of valve-opening of the fresh air introduction valve 32, the ECU 50 controls the electronic throttle device 6 to close to a final target throttle opening degree TTA. Thus, the ECU 50 regulates a total amount of intake air introduced to the engine 1. Accordingly, when the ECU 50 determines deceleration of the engine 1 during not-increase in pressure, fresh air is quickly introduced to the intake passage 2 downstream of the electronic throttle device 6, and thus EGR gas remaining in the intake passage 2 is diluted. Further, a total amount of intake air including intake air having passed through the electronic throttle device 6 added with fresh air is quickly regulated to an appropriate amount as a target intake amount AFMgaA. Therefore, both the electronic throttle device 6 and the fresh air introduction valve 32 are used during deceleration of the engine 1 from the term of not-increase in pressure, thereby appropriately preventing misfire of the engine 1 due to influence of the remaining EGR gas.

According to the configuration of the present embodiment, the ECU 50 calculates a target throttle opening degree THRtaC based on a target passing intake amount THRgaC obtained by subtracting a fresh air introduction amount ABVgaB from a target intake amount AFMgaA of the engine 1. Therefore, the ECU 50 controls the electronic throttle device 6 to open to the target throttle opening degree THRtaC such that the intake amount of intake air passing through the electronic throttle device 6 is regulated to an appropriate amount without any excess or shortage in the amount. Therefore, the total amount of intake air introduced to the engine 1 during deceleration is accurately regulated to the target intake amount AFMgaA.

According to the configuration of the present embodiment, the fresh air introduction valve 32 is opened, and then the opening degree of the fresh air introduction valve 32 is gradually decreased from the final target fresh-air opening degree TTABV in association with decrease in the remaining EGR gas ratio. An opening degree of the electronic throttle device 6 is gradually increased according to the decrease in the opening degree of the fresh air introduction valve 32. Accordingly, the fresh air introduction valve 32 is closed and an opening degree of the electronic throttle device 6 is regulated to a necessary final target throttle opening degree TTA while preventing sudden change in the total intake amount of the intake air introduced to the engine 1. Therefore, the ratio of EGR gas remaining in the intake passage 2 relative to intake air can be quickly decreased, and the intake air control can be gradually returned to general intake air control while stable combustion is maintained in the engine 1.

According to the configuration of the present embodiment, the electronic throttle device 6 has relatively high responsivity since the device 6 is configured by an electrically operated valve of a DC motor type. On the other hand, the fresh air introduction valve 32 has relatively low responsivity since the valve 32 is configured by an electrically operated valve of a step motor type. In response to this, the ECU 50 adds a predetermined value β to a calculated target throttle opening degree THRtaC with expecting delay in valve-opening of the fresh air introduction valve 32 with low responsivity. Accordingly, even if fresh air is delayed to be introduced to the intake passage 2 during deceleration of the engine 1, an increase in the intake air compensates for insufficient fresh air. Therefore, a total intake amount of intake air introduced to the engine 1 during deceleration can be accurately regulated to a target intake amount AFMgaA while achieving cost reduction and size reduction of the fresh air introduction valve 32 by adopting a step-motor type.

### Second Embodiment

Next, a second embodiment embodying an engine system according to the present invention will be described in detail with reference to the accompanying drawings.

Hereinafter, components same as those of the first embodiment will be designated by the same reference signs. The same components will not be described in detail, and difference will mainly be described.

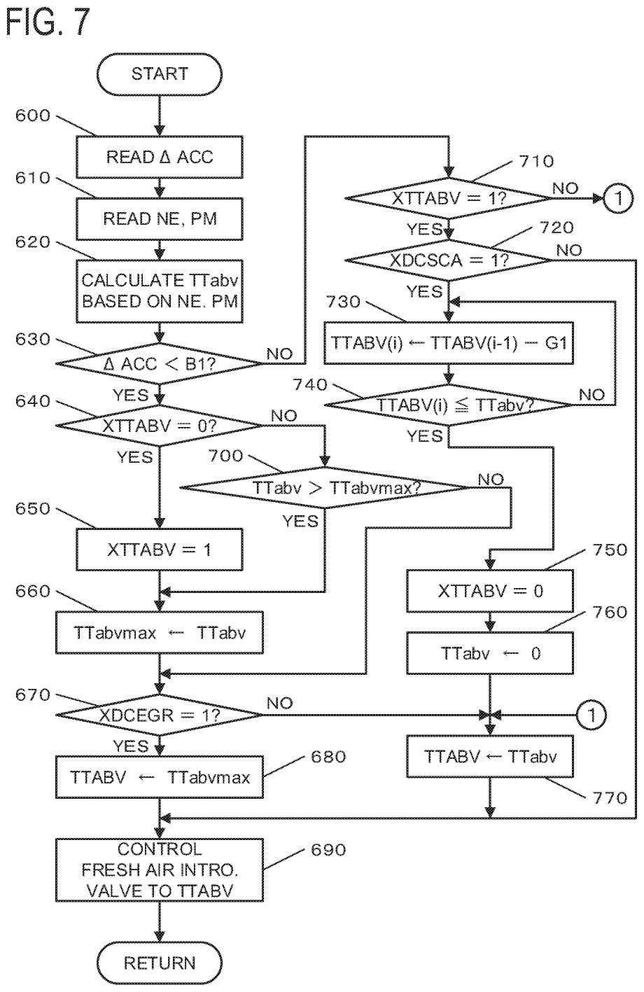

The present embodiment differs from the first embodiment in contents of intake air control and fresh air introduction control performed based on determination of deceleration of an engine 1 and others. FIG. 7 is a flowchart illustrating contents of calculation of a final target fresh-air opening degree TTABV and fresh air introduction control during operation of the engine 1.

When a process proceeds to the routine, an ECU 50 reads an accelerator closing or opening speed ΔACC based on a detected value of an accelerator sensor 47 in step 600. The ECU 50 obtains the accelerator closing or opening speed ΔACC by subtracting a previous accelerator opening degree ACC from a current accelerator opening degree ACC.

Next, in step 610, the ECU 50 reads an engine rotational speed NE and an intake pressure PM based on a detected value of a rotation speed sensor 45 and a detected value of an intake-air pressure sensor 43.

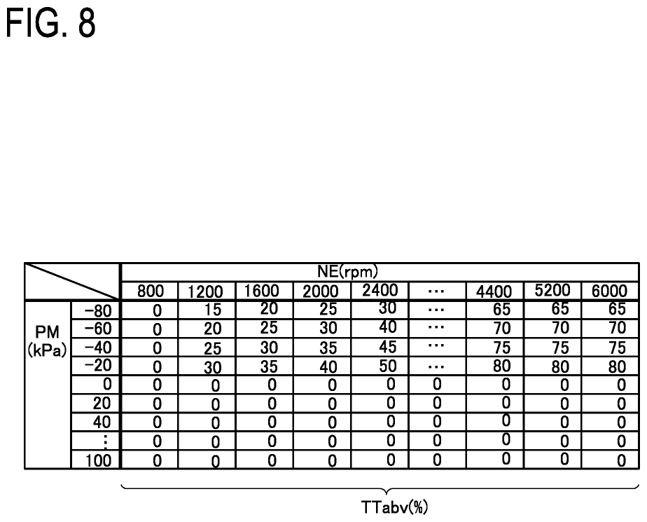

Next, in step 620, the ECU 50 calculates a target fresh-air opening degree TTabv based on the read engine rotational speed NE and the read intake pressure PM. The ECU 50 obtains the target fresh-air opening degree TTabv corresponding to the engine rotational speed NE and the intake pressure PM by referring to a target fresh-air opening degree map as shown in FIG. 8, for example.

The target fresh-air opening degree map includes a predetermined fresh-air opening degree (the target fresh-air opening degree TTabv) corresponding to the engine rotational speed NE and the intake pressure PM which represent an operation state of the engine 1. In the map, the target fresh-air opening degree TTabv includes a fully closed position (0%), maximum opening degrees (30% to 80%), and various intermediate opening degrees (15% to 75%) between the fully closed position (0%) and the maximum opening degrees (30% to 80%). When an engine rotational speed NE is equal to or lower than “800 rpm”, the target fresh-air opening degree TTabv is set to “0%” (a fully closed position) in the map irrespective of the intake pressure PM. When the intake pressure PM is equal to or higher than “0 kPa” (an atmospheric pressure or a positive pressure), the target fresh-air opening degree TTabv is set to “0%” (a fully closed position) irrespective of the engine rotational speed NE. For each of intake pressures PM of intake air below “0 kPa” (negative pressures) in the map, a target fresh-air opening degree TTabv is set to gradually increase as the engine rotational speed NE increases within a range “from 1200 rpm to 6000 rpm” per difference (−20 kPa to −80kPa) in the intake pressure PM (negative pressure). According to this, when the intake pressure PM is “−20 kPa” (negative pressure), the target fresh-air opening degree TTabv is set to a maximum opening degree (30% to 80%) according to differences in the engine rotational speed NE. The target fresh-air opening degree TTabv is made to gradually decrease from a maximum opening degree (30% to 80%) as negative pressure of the intake pressure PM increases (as an absolute value increases) within a range “from −20 kPa to −80 kPa” per differences (1200 rpm to 6000 rpm) in the rotational speed NE.

Next, in step 630, the ECU 50 determines whether the read accelerator closing or opening speed ΔACC is smaller than a predetermined value B1. For example, “−3%/4 ms” may be used as the predetermined value B1. The ECU 50 shifts the process to step 640 when the determination result is affirmative since the speed of closing of a throttle valve 6a is fast (a sudden deceleration). Alternatively, the ECU 50 shifts the process to step 710 when the determination result is negative since the speed of closing of the throttle valve 6a is slow.

In step 640, the ECU 50 determines whether a maximum opening-degree holding start flag XTTABV is “0”. As described later, this flag XTTABV is set to “1” when the target fresh-air opening degree TTabv has been started to be held at a maximum target fresh-air opening degree TTabvmax as a maximum opening degree. Alternatively, the flag XTTABV is set to “0” when the target fresh-air opening degree TTabv has been released from holding at the maximum target fresh-air opening degree TTabvmax. The ECU 50 shifts the process to step 650 when the determination result is affirmative since the target fresh-air opening degree TTabv has been released from holding at the maximum target fresh-air opening degree TTabvmax. Alternatively, the ECU 50 shifts the process to step 700 when the determination result is negative since the target fresh-air opening degree TTabv has been started to be kept (held) at the maximum target fresh-air opening degree TTabvmax.

In step 650, the ECU 50 sets the maximum opening-degree holding start flag XTTABV to “1” since the target fresh-air opening degree TTabv has been started to be held at the maximum target fresh-air opening degree TTabvmax in a current control cycle.

Next, in step 660, the ECU 50 sets (or holds) the target fresh-air opening degree TTabv to the maximum target fresh-air opening degree TTabvmax. That is, the ECU 50 sets or keeps the target fresh-air opening degree TTabv to a maximum opening degree (30% to 80%) in the target fresh-air opening degree map in FIG. 8.

On the other hand, when the process proceeds to step 700 from step 640, the ECU 50 determines whether the currently calculated target fresh-air opening degree TTabv is larger than the maximum target fresh-air opening degree TTabvmax that has already been kept. The ECU 50 shifts the process to step 660 to update the maximum target fresh-air opening degree

TTabvmax when the determination result is affirmative. Alternatively, the ECU 50 shifts the process to step 670 when the determination result is negative.

Next, in step 670, the ECU 50 determines whether a deceleration EGR flag XDCEGR is “1”. The ECU 50 shifts the process to step 680 when the determination result is affirmative since there is remaining EGR gas during deceleration. Alternatively, the ECU 50 shifts the process to step 770 when the determination result is negative since there is no remaining EGR gas during deceleration.

Next, in step 680, the ECU 50 sets the maximum target fresh-air opening degree TTabvmax as the final target fresh-air opening degree TTABV. That is, the final target fresh-air opening degree TTABV is held at the maximum target fresh-air opening degree TTabvmax.

Next, in step 690, the ECU 50 controls the fresh air introduction valve 32 to open to the final target fresh-air opening degree TTABV and returns the process to step 600. Thus, an opening degree of the fresh air introduction valve 32 is held at the maximum target fresh-air opening degree TTabvmax during deceleration of the engine 1.

On the other hand, when the process proceeds to step 770 from step 670, the ECU 50 sets the target fresh-air opening degree TTabv as the final target fresh-air opening degree TTABV and shifts the process to step 690. In that case, according to the process in step 690, an opening degree of the fresh air introduction valve 32 is not held at the maximum target fresh-air opening degree TTabvmax but is controlled to be the target fresh-air opening degree TTabv corresponding to an operation state of the engine 1 (the engine rotational speed NE and the intake pressure PM).

On the other hand, when the process proceeds to step 710 from step 630, the ECU 50 determines whether the maximum opening-degree holding start flag XTTABV is “1”. The ECU 50 shifts the process to step 720 when the determination result is affirmative since the target fresh-air opening degree TTabv starts to be held at the maximum target fresh-air opening degree TTabvmax. Alternatively, the ECU 50 shifts the process to step 770 when the determination result is negative since the target fresh-air opening degree TTabv is released from holding at the maximum target fresh-air opening degree TTabvmax.

When the process proceeds to step 770 from step 710, the ECU 50 sets the target fresh-air opening degree TTabv as the final target fresh-air opening degree TTABV in step 770. In step 690, the ECU 50 controls the fresh air introduction valve 32 to open to the final target fresh-air opening degree TTABV. In that case too, an opening degree of the fresh air introduction valve 32 is not held at the maximum target fresh-air opening degree TTabvmax but is controlled to open to the target fresh-air opening degree TTabv corresponding to the operation state of the engine 1 (the engine rotational speed NE and the intake pressure PM).

When the process proceeds to step 720 from step 710, the ECU 50 determines whether a deceleration scavenging flag XDCSCA is “1”. A process in which the deceleration scavenging flag XDCSCA is set will be described later. The ECU 50 shifts the process to step 730 when the determination result is affirmative since scavenging of remaining EGR gas during deceleration is completed. Alternatively, the ECU 50 shifts the process to step 690 when the determination result is negative since scavenging of the remaining EGR gas during deceleration is not completed. Therefore, in that case, an opening degree of the fresh air introduction valve 32 becomes held at the maximum target fresh-air opening degree TTabvmax in step 690.

On the other hand, in step 730, the ECU 50 calculates a current final target fresh-air opening degree TTABV(i) by subtracting a predetermined value G1 from a previous final target fresh-air opening degree TTABV(i-1). Based on the current final target fresh-air opening degree TTABV(i), the ECU 50 controls the fresh air introduction valve 32 to gradually close. For example, “two steps” (a control amount of a step motor 36) may be used as the predetermined value G1.

Next, in step 740, the ECU 50 determines whether the calculated final target fresh-air opening degree TTABV(i) is equal to or smaller than the target fresh-air opening degree TTabv. The ECU 50 shifts the process to step 750 when the determination result is affirmative. Alternatively, the ECU 50 returns the process to step 730 when the determination result is negative, and repeats the processing of steps 730 and 740. By these processes, the opening degree of the fresh air introduction valve 32 is gradually decreased.

When the process proceeds to step 750 from step 740, the ECU 50 sets the maximum opening degree holding start flag XTTABV to “0”.

Next, in step 760, the ECU 50 sets the target fresh-air opening degree TTabv to “0” to fully close the fresh air introduction valve 32. Then, the ECU 50 shifts the process to steps 770 and 690. By these processes, the fresh air introduction valve 32 is controlled to be fully closed.

According to the above configuration, the ECU 50 includes a target fresh-air opening degree map set in advance with the predetermined fresh-air opening degree (target fresh-air opening degree TTabv) according to the operation state of the engine 1 (the engine rotational speed NE and the intake pressure PM). In the map, the predetermined fresh-air opening degree (target fresh-air opening degree TTabv) includes a fully closed position (0%), maximum opening degrees (the maximum target fresh-air opening degree TTabvmax (30% to 80%)), and various intermediate opening degrees (15% to 75%) between the fully closed position and the maximum opening degrees.

According to the above control, during not-increase in pressure, the ECU 50 controls the fresh air introduction valve 32 to open by a predetermined opening degree. Further, when the ECU 50 determines deceleration of the engine 1 during not-increase in pressure, the ECU 50 sets the fresh-air opening degree to a maximum opening degree (maximum target fresh-air opening degree TTabvmax) in accordance with the operation state of the engine 1 (the engine rotational speed NE and the intake pressure PM) at a start of deceleration by refereeing to the target fresh-air opening degree map so that the fresh air introduction valve 32, which has been controlled to open by the predetermined fresh-air opening degree, is kept under the valve-opening state.

According to the above control, during pressure increase, the ECU 50 sets a predetermined fresh-air opening degree of the fresh air introduction valve 32 to a fully closed position (0%) by referring to the target fresh-air opening degree map. Further, when the ECU 50 determines deceleration of the engine 1 during pressure increase, the ECU 50 determines a predetermined fresh-air opening degree by referring the target fresh-air opening degree map so that the fresh air introduction valve 32 is controlled to open to a predetermined fresh-air opening degree from the fully closed state after the intake pressure decreases to the negative pressure.

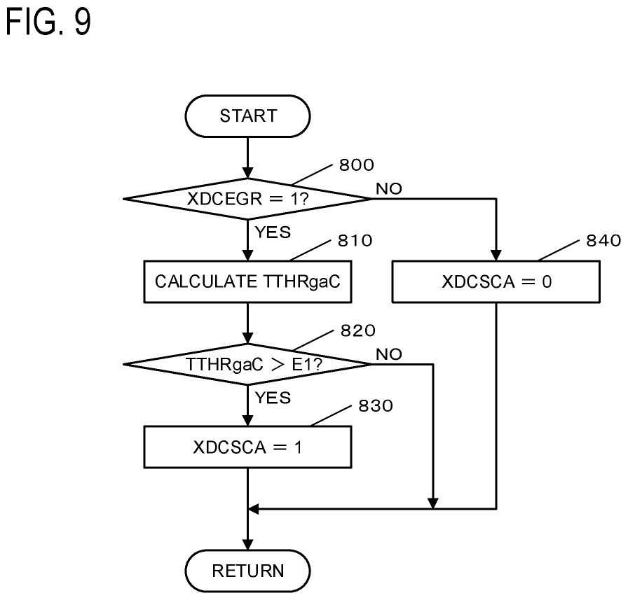

Next, a determination as to whether scavenging of EGR gas remaining in the intake passage 2 during deceleration of the engine 1 is completed will be described. FIG. 9 is a flowchart illustrating a processing content for this determination.

When a process proceeds to the routine, in step 800, the ECU 50 determines whether the deceleration EGR flag XDCEGR is “1”. The ECU 50 shifts the process to step 810 when the determination result is affirmative since EGR gas remains in the intake passage 2 during deceleration. Alternatively, the ECU 50 shifts the process to step 840 when the determination result is negative since EGR gas does not remain in the intake passage 2 during deceleration.

In step 810, the ECU 50 calculates an accumulated intake amount (accumulated passing intake amount) TTHRgaC of intake air having passed through an electronic throttle device 6 (throttle valve 6a) since the start of deceleration. The ECU 50 can obtain the accumulated passing intake amount TTHRgaC based on an intake amount Ga detected by the air flow meter 42 after the start of deceleration.

Next, in step 820, the ECU 50 determines whether the accumulated passing intake amount TTHRgaC is larger than a predetermined value E1. The value E1 may be assumed to be the one which is approximated to an inside volume of the intake passage 2 downstream of an outlet 22b of an EGR passage 22. The ECU 50 shifts the process to step 830 when the determination result is affirmative since scavenging of the remaining EGR gas during deceleration is completed. Alternatively, the ECU 50 returns the process to step 800 when the determination result is negative since scavenging of the remaining EGR gas during deceleration is not completed.

In step 830, the ECU 50 sets a deceleration scavenging flag XDCSCA to “1” and returns the process to step 800.

On the other hand, when the process proceeds to step 840 from step 800, the ECU 50 sets the deceleration scavenging flag XDCSCA to “0” and returns the process to step 800.

According to the above control, the ECU 50 determines completion of scavenging of EGR gas remaining in the intake passage 2 based on the accumulated intake amount (the accumulated passing intake amount) TTHRgaC of the intake air having passed through the electronic throttle device 6 (throttle valve 6a) since the start of deceleration. Then the ECU 50 sets a deceleration scavenging flag XDCSCA that is to be referred to in the flowchart in FIG. 7.

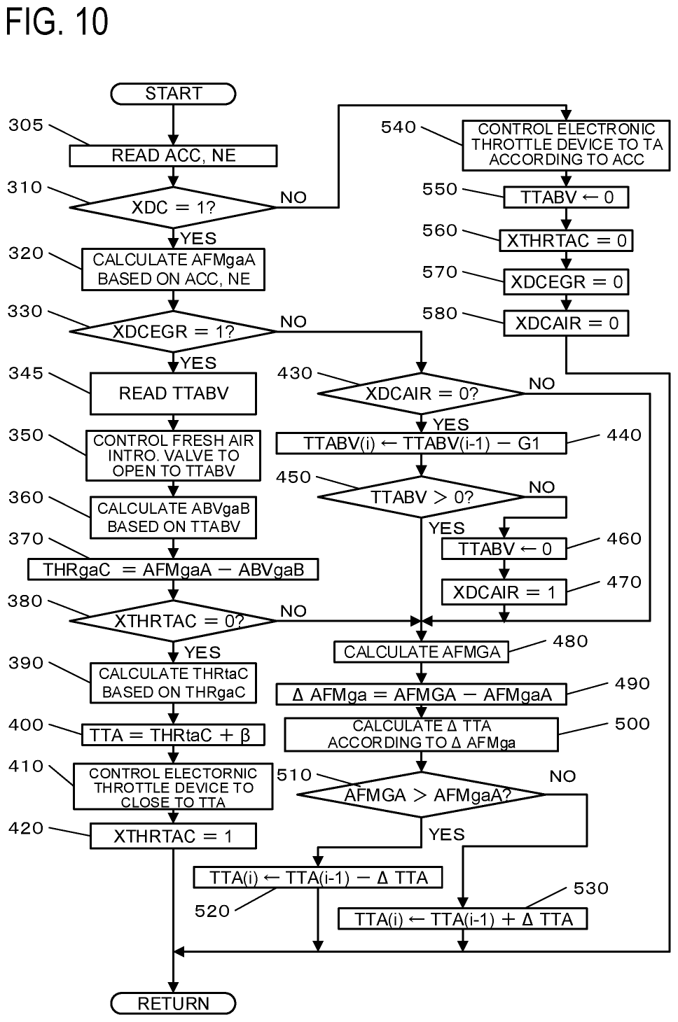

Next, the intake-air control and the fresh air introduction control performed based on the determination of deceleration of the engine 1 and others described above will be described. FIG. 10 is a flowchart illustrating the contents of the intake air control and the fresh air introduction control.

Contents of steps 305 and 345 in the flowchart in FIG. 10 are different from those of steps 300 and 340 in the flowchart in FIG. 3, respectively. Other contents of steps 310 to 330 and 350 to 580 in the flowchart in FIG. 10 are the same as those in the flowchart in FIG. 3.

That is, the ECU 50 reads the accelerator opening degree ACC and the engine rotational speed NE based on a detected value of the accelerator sensor 47 and a detected value of the rotation speed sensor 45 in step 305. Further, in step 345, the ECU 50 reads a final target fresh-air opening degree TTABV obtained in the flowchart in FIG. 7.

According to the above control, unlike the control in the flowchart in FIG. 3, when the ECU 50 determines deceleration of the engine 1 during not-increase in pressure, the ECU 50 keeps opening the fresh air introduction valve 32, which has been controlled to open to a predetermined opening degree (a final target fresh-air opening degree TTABV=a maximum target fresh-air opening degree TTabvmax).

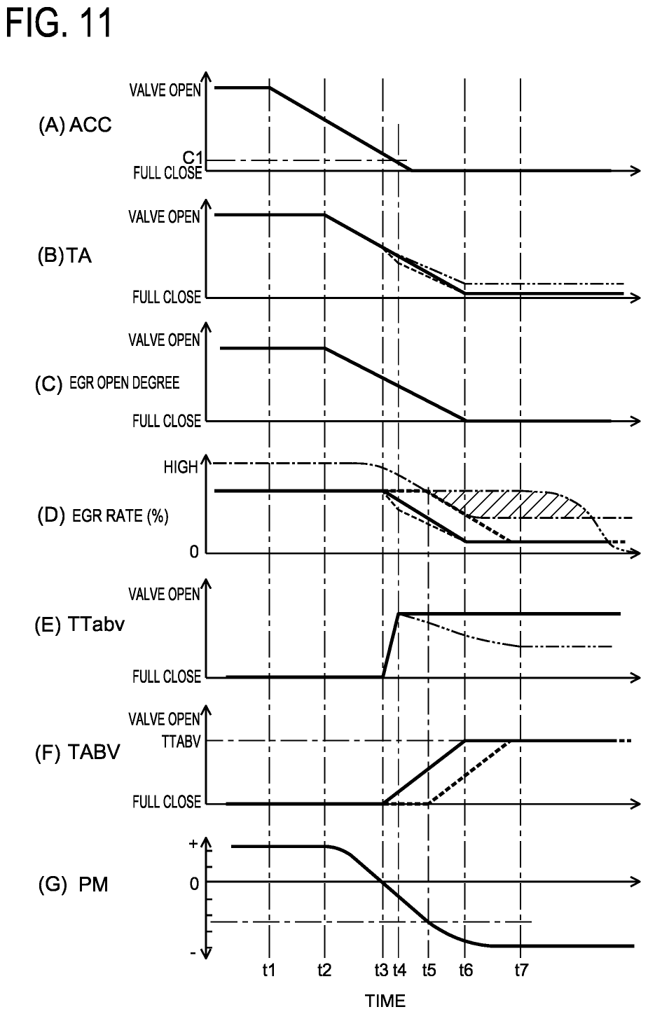

Herein, examples of behavior of various parameters related to the above control will be described. FIG. 11 is time charts illustrating behaviors of various parameters when the engine 1 decelerates from a supercharging region (during pressure increase) in the present embodiment, the time charts corresponding to those of FIG. 5. In FIG. 11(A) to (G), bold lines represent behavior of the various parameters of the present embodiment. In the present embodiment, in FIG. 11, a bold line in the time chart (E) indicating behavior of the target fresh-air opening degree map TTabv determined by referring to the target fresh-air opening degree map, a broken line in the time chart (B) indicating behavior of the throttle opening degree TA when the fresh air introduction valve 32 is controlled to open by the target fresh-air opening degree TTabv, the behavior being determined by referring to the target fresh-air opening degree map, and a broken line in the time chart (D) indicating behavior of the EGR ratio when the fresh air introduction valve 32 is controlled to open to the target fresh-air opening degree TTabv, the behavior being determined by referring to the target fresh-air opening degree map are different from those indicated in the time charts (B), (D), and (E) of FIG. 5, respectively. However, the effect of preventing misfire on deceleration is basically similar to that of the present embodiment.

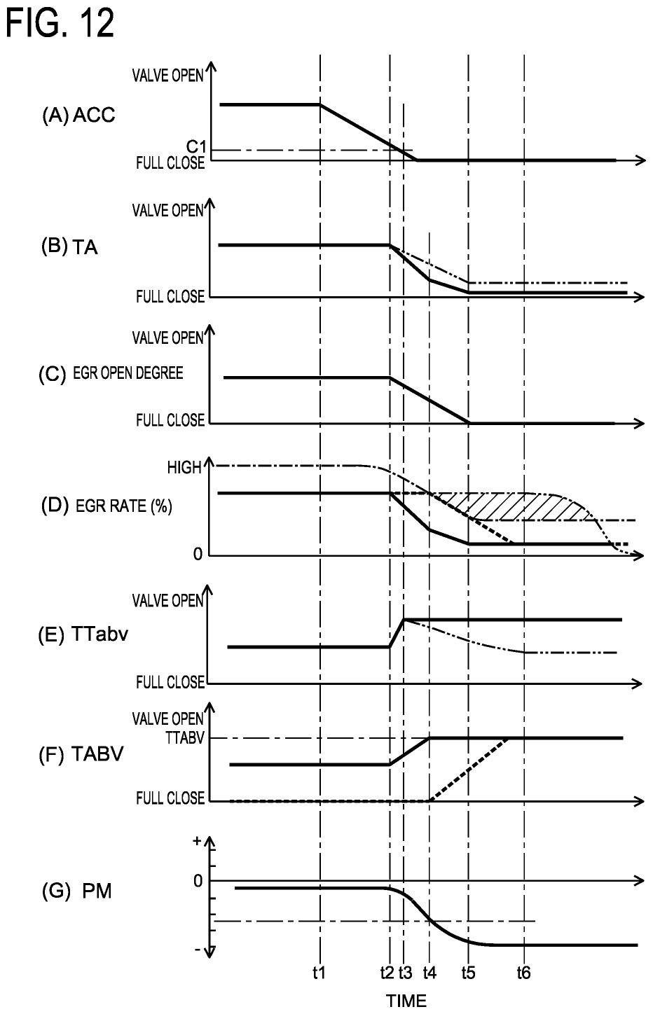

FIG. 12 is time charts illustrating the behavior of various parameters in a case where the engine 1 decelerates from a non-supercharging region (during not-increase in the intake pressure) corresponding to the time charts in FIG. 6. In FIGS. 12(A) to (G), bold lines represent behavior of the various parameters of the present embodiment. Behavior of various parameters in the present embodiment is different from that of various parameters in FIG. 6 in the following points. That is, since the engine 1 decelerates from a non-supercharging region, the target fresh-air opening degree TTabv determined by referring to the target fresh-air opening degree map and the actual fresh-air opening degree TABV are not in the fully-closed position but opened by predetermined opening degrees before time t2 prior to deceleration as represented by bold lines in FIGS. 12(E) and (F).

Then, when it is determined at a time t2 that EGR gas remains in the intake passage 2 during deceleration (XDCEGR=1), the target fresh-air opening degree TTabv determined by referring to the target fresh-air opening degree map increases to a maximum opening degree until a time t3 as represented by a bold line in FIG. 12(E). At that time, as represented by a bold line in FIG. 12(F), the actual fresh-air opening degree TABV increases to a maximum opening degree that is a final target fresh-air opening degree TTABV until a time t4 (the fresh air introduction valve 32 starts to be opened). After the time t4, the actual fresh-air opening degree TABV is kept at the maximum opening degree. The throttle opening degree TA decreases accordingly as varying speeds from a time t2 to a time t5 as represented by a bold line in FIG. 12(B). Consequently, EGR ratio decreases as varying the speed from the time t2 to the time t5 as represented by a bold line in FIG. 12(D).

A chain double-dotline in each of FIG. 11(E) and FIG. 12(E) represents variation in the target fresh-air opening degree TTabv determined according to the intake pressure PM by referring to the target fresh-air opening degree map at a time when the engine rotational speed NE is “2000 rpm”.

A configuration of an engine system according to the present embodiment described above has following operations and effects in addition to those of the configuration of the first embodiment. That is, the ECU 50 controls the fresh air introduction valve 32 to open by a predetermined fresh-air opening degree (a final target fresh-air opening degree TTABV=a maximum target fresh-air opening degree TTabvmax) during not-increase in pressure. Further, when the ECU 50 determines deceleration of the engine 1 during not-increase in pressure, the ECU 50 expects delay in valve-opening of the fresh air introduction valve 32 with low responsivity, and thus holds the valve-opening state of the fresh air introduction valve 32, which has been controlled to open to the predetermined opening degree (the final target fresh-air opening degree TTABV=the maximum target fresh-air opening degree TTabvmax) and controls the electronic throttle device 6 to close to a predetermined intake opening degree (final target throttle opening degree TTA). Accordingly, when the ECU 50 determines deceleration of the engine 1, fresh air passes through the fresh air introduction valve 32 which has been opened, and the fresh air is immediately introduced to the intake passage 2 downstream of the electronic throttle device 6. Thus, EGR gas remaining in the intake passage 2 is diluted, and a total intake amount of intake air having passed through the electronic throttle device 6 added with fresh air is quickly regulated to an appropriate amount. Accordingly, the engine system can preferably prevent misfire in the engine 1 due to the influence of the remaining EGR gas by using both the electronic throttle device 6 and the fresh air introduction valve 32 during deceleration of the engine 1 from the term of not-increase in pressure.

According to the configuration of the present embodiment, the ECU 50 sets the target fresh-air opening degree TTabv corresponding to the operation state of the engine 1 (the engine rotational speed NE and the intake pressure PM) by referring to the target fresh-air opening degree map, so that the fresh air introduced to the intake passage 2 is appropriately regulated according to the operation state of the engine 1. That is, when the ECU 50 determines deceleration of the engine 1 during not-increase in pressure, the ECU 50 sets the fresh-air opening degree to a maximum opening degree (maximum target fresh-air opening degree TTabvmax) according to the operation state of the engine 1 (the engine rotational speed NE and the intake pressure PM) at the start of deceleration by referring to the target fresh-air opening degree map so that the ECU 50 holds the valve-opening state of the fresh air introduction valve that has been controlled to open to the predetermined opening degree. Accordingly, when the engine 1 decelerates during not-increase in pressure, an opening degree of the fresh air introduction valve 32 is held at an optimum maximum opening degree (maximum target fresh-air opening degree TTabvmax) according to the operation state of the engine 1 (the engine rotational speed NE and the intake pressure PM). Therefore, during not-increase in pressure, the engine system can quickly introduce an appropriate amount of fresh air according to the operation state of the engine 1 to the intake passage 2 from the time of deceleration of the engine 1 by referring to the target fresh-air opening degree map.

According to the configuration of the present embodiment, during pressure increase, the ECU 50 sets a predetermined fresh-air opening degree of the fresh air introduction valve 32 to be fully closed by referring to the target fresh-air opening degree map. Accordingly, during pressure increase, the fresh air introduction valve 32 is controlled to close to the fully closed position, and then the fresh air introduction passage 31 is shut off.

Consequently, intake air can be prevented from flowing backward into the fresh air introduction passage 31 during pressure increase.

According to the configuration of the present embodiment, when the ECU 50 determines deceleration of the engine 1 during pressure increase, the ECU 50 determines a predetermined fresh-air opening degree (target fresh-air opening degree TTabv) corresponding to the operation state of the engine 1 (the engine rotational speed NE and the intake pressure PM) by referring to the target fresh-air opening degree map so that the fresh air introduction valve 32 is controlled to open to the predetermined fresh-air opening degree from the fully closed position after the intake pressure decreases to the negative value. Accordingly, in deceleration of the engine during pressure increase, the fresh air introduction valve 32 is opened from a fully closed position to an optimum fresh-air opening degree according to the operation state of the engine after the intake pressure has turned negative. Therefore, when the engine 1 decelerates, an appropriate amount of fresh air corresponding to the operation state of the engine 1 can be introduced to the intake passage 2 after the intake pressure decreases to negative pressure.

### Third Embodiment

Next, a third embodiment embodying an engine system according to an aspect of the present invention will be described in detail with reference to the accompanying drawings.

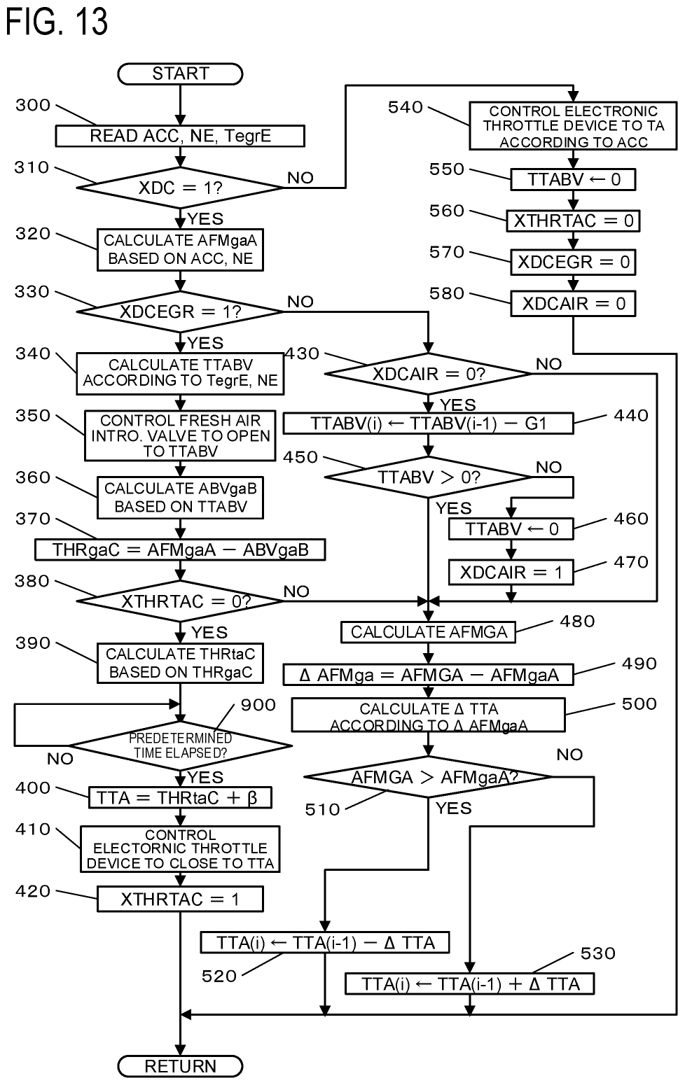

The present embodiment differs from the first embodiment in intake air control and fresh air introduction control performed based on determination of deceleration and others of an engine 1. FIG. 13 is a flowchart illustrating those control contents.

This flowchart is different from the flowchart in FIG. 3 in view that step 900 is provided between steps 390 and 400. Other steps 300 to 580 are the same as those in the flowchart in FIG. 3.

That is, when a process proceeds to step 900 from step 390, the ECU 50 shifts the process to step 400 after a predetermined period of time has elapsed since execution of step 390.

According to the above control, unlike the control in the first embodiment, the ECU 50 controls an electronic throttle device 6 to delay its timing of starting valve-closing by a predetermined period of time from a start of opening the fresh air introduction valve 32 with expecting delay in valve opening of the fresh air introduction valve 32 having low responsivity.

According to a configuration of an engine system of the present embodiment described above has the following operations and effects in addition to those of the configuration of the first embodiment. That is, even if introduction of fresh air to the intake passage 2 is delayed during deceleration of the engine 1, deficient fresh air is compensated for by the delay in a decrease in the intake air according to the above control by the ECU 50. This configuration can achieve accurate regulation of a total intake amount of intake air introduced to the engine 1 to the target intake amount AFMgaA while also achieving cost reduction and size reduction of the fresh air introduction valve 32 of a step motor type.

### Fourth Embodiment

Next, a fourth embodiment embodying an engine system according to the present invention will be described in detail with reference to the accompanying drawings.

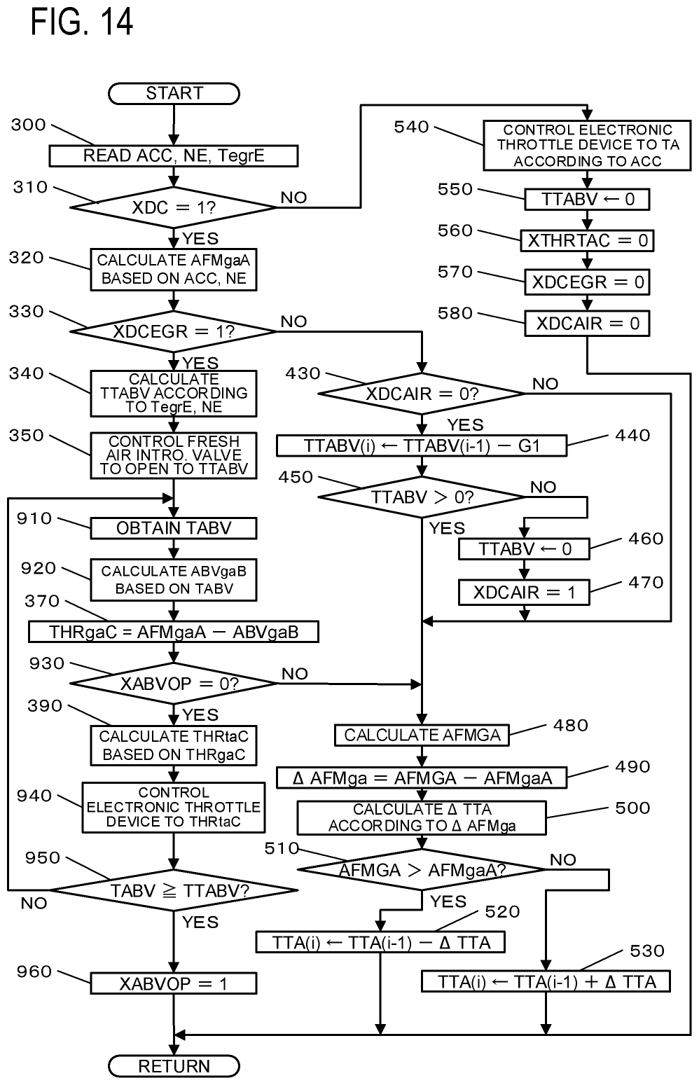

The present embodiment differs from the first embodiment in contents of intake air control and fresh air introduction control performed based on determination of deceleration of an engine 1 and others. FIG. 14 is a flowchart illustrating those control contents.

This flowchart is different from the flowchart in FIG. 3 in view that steps 910 to 960 are provided instead of steps 360, 380, and 400 to 420. Contents of other steps 300 to 350 and 430 to 580 are the same as those in the flowchart in FIG. 3.

That is, when a process proceeds to step 910 from step 350, an ECU 50 reads an actual opening degree TABV of a fresh air introduction valve 32. The ECU 50 obtains the actual fresh-air opening degree TABV from an instruction value (the number of steps) given to a step motor 36 of the fresh air introduction valve 32 that is under control.

Next, in step 920, the ECU 50 calculates a fresh-air introduction amount ABVgaB based on the determined actual fresh-air opening degree TABV. The ECU 50 obtains the fresh-air introduction amount ABVgaB with respect to the actual fresh-air opening degree TABV by referring to a predetermined fresh-air introduction amount map (not shown).

Next, in step 370, the ECU 50 calculates a target intake amount (target passing intake amount) THRgaC of intake air passing through a throttle valve 6a by subtracting the fresh-air introduction amount ABVgaB from a target intake amount AFMgaA.

Next, in step 930, the ECU 50 determines whether a target fresh-air opening degree flag XABVOP is “0”. As described later, the flag XABVOP is set to “1” when an opening degree of the fresh air introduction valve 32 has reached a final target fresh-air opening degree TTABV. Alternatively, the flag XABVOP is set to “0” when the above condition is not applied. The ECU 50 shifts the process to step 390 when the determination result is affirmative since the fresh air introduction valve 32 has not reached the final target fresh-air opening degree TTABV. Alternatively, the ECU 50 shifts the process to step 480 when the determination result is negative since the opening degree of the fresh air introduction valve 32 has reached the final target fresh-air opening degree TTABV.

In step 390, the ECU 50 calculates a target throttle opening degree THRtaC based on the calculated target passing intake amount THRgaC. The ECU 50 obtains the target throttle opening degree THRtaC with respect to the target passing intake amount THRgaC by referring to a predetermined target throttle opening degree map (not shown).

Next, in step 940, the ECU 50 controls the electronic throttle device 6 to close to the target throttle opening degree THRtaC.

Next, in step 950, the ECU 50 determines whether the actual fresh-air opening degree TABV of the fresh air introduction valve 32 is equal to or larger than the final target fresh-air opening degree TTABV. The ECU 50 shifts the process to step 960 when the determination result is affirmative since the actual fresh-air opening degree TABV has reached the final target fresh-air opening degree TTABV. Alternatively, the ECU 50 returns the process to step 910 when the determination result is negative since the actual fresh-air opening degree TABV has not reached the final target fresh-air opening degree TTABV.

Then, in step 960, the ECU 50 sets the target fresh-air opening degree flag XABVOP to “1” and returns the process to step 300.

According to the above control, unlike the first embodiment, the ECU 50 successively obtains the actual fresh-air opening degree TABV of the fresh air introduction valve 32 in valve-opening control of the fresh air introduction valve 32 with expecting delay in valve opening of the fresh air introduction valve 32 having low responsivity. The ECU 50 then calculates an intake opening degree (target throttle opening degree THRtaC) according to the obtained actual fresh-air opening degree TABV, and controls the electronic throttle device 6 to close to the calculated target throttle opening degree THRtaC.

According to a configuration of the present embodiment, the engine system described above has following operations and effects in addition to those of the configuration of the first embodiment. That is, according to the above control by the ECU 50, even if introduction of the fresh air to the intake passage 2 during deceleration of the engine 1 is delayed, deficient fresh air is compensated for by the intake air which has been regulated according to the actual fresh-air opening degree TABV of the fresh air introduction valve 32. This configuration can achieve accurate regulation of a total intake amount of intake air introduced to the engine 1 during deceleration to the target intake amount AFMgaA while also achieving cost reduction and size reduction in the fresh air introduction valve 32 by adopting a step motor type.

### Fifth Embodiment

Next, a fifth embodiment embodying an engine system according to the present invention will be described in detail with reference to the accompanying drawings.

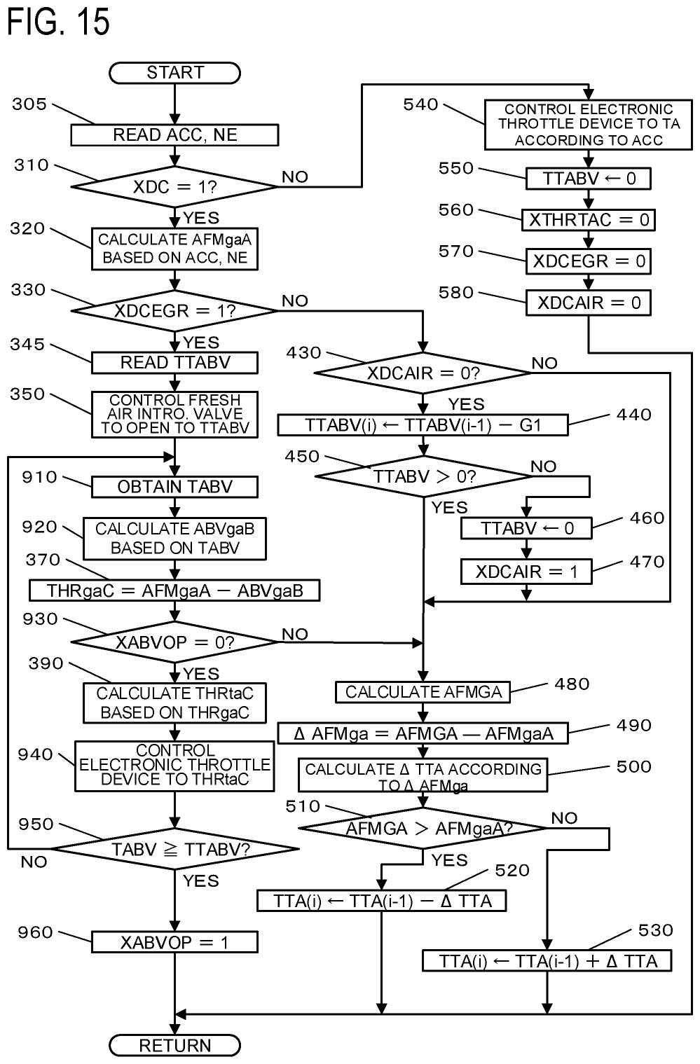

The present embodiment differs from the second embodiment in contents of intake air control and fresh air introduction control performed based on determination of deceleration of an engine 1 and others. FIG. 15 is a flowchart illustrating those control contents.

This flowchart is different from the flowchart in FIG. 10 in view that steps 910 to 960 are provided instead of steps 360, 380, and 400 to 420. Other steps 300 to 350 and 430 to 580 in the flowchart are the same as those in the flowchart in FIG. 10.

Steps 350 to 960 in FIG. 16 according to the present embodiment are the same as those in the flowchart in FIG. 14, and they are omitted their explanation.

Accordingly, a configuration of the present embodiment yields operations and effects similar to those of the fourth embodiment.

The present invention is not limited to the embodiments described above. Part of a configuration of each embodiment may be appropriately modified without departing from the scope of the invention.

(1) In each of the embodiments described above, the electronic throttle device 6 is configured by a DC motor type, and the fresh air introduction valve 32 is configured by a step motor type. Alternatively, both the electronic throttle device 6 and the fresh air introduction valve 32 may be configured by the step motor type or the DC motor type.

(2) In each of the embodiments described above, deceleration of the engine 1 is determined based on the accelerator opening degree ACC detected by the accelerator sensor 47. Alternatively, deceleration of the engine 1 may be determined based on the throttle opening degree TA detected by the throttle sensor 41.

(3) In each of the embodiments described above, a check valve may be provided in the fresh air introduction passage 31 on a side of the fresh air outlets 33b relative to a side of the fresh air introduction valve 32. The check valve allows fresh air to flow from the fresh air introduction valve 32 to the fresh air outlets 33b, but shuts off flow of intake air and the like from the fresh air outlets 33b to the fresh air introduction valve 32. Such a configuration can surely prevent backflow of intake air and the like to the fresh air introduction passage 31 during pressure increase. Further, the check valve allows the fresh air introduction valve 32 to be opened before pressure of intake air decreases to negative pressure from the state of pressure increase. Therefore, the check valve also can deal with response delay of the fresh air introduction valve 32.

### INDUSTRIAL APPLICABILITY

The present invention can be applied to an engine system including an engine provided with a supercharger, an intake amount regulation valve, an EGR device of a low-pressure loop type provided with an EGR valve, and a fresh air introduction device provided with a fresh air introduction valve.

### REFERENCE SIGNS LIST

1 Engine
2 Intake passage
3 Exhaust passage
5 Supercharger
5a Compressor
5b Turbine
5c Rotary shaft
6 Electronic throttle device (Intake amount regulation valve)
6a Throttle valve
11 DC Motor
21 EGR Device (Exhaust gas recirculation device)
22 EGR Passage (Exhaust gas recirculation passage)
22a Inlet
22b Outlet
23 EGR Valve (Exhaust gas recirculation valve)
31 Fresh air introduction passage
31a Inlet
32 Fresh air introduction valve
36 Step motor
41 Throttle sensor (Operation state detection unit)
42 Air flow meter (Operation state detection unit)
43 Intake air pressure sensor (Operation state detection unit)
44 Water temperature sensor (Operation state detection unit)
45 Rotation speed sensor (Operation state detection unit)
46 Oxygen sensor (Operation state detection unit)
47 Accelerator sensor (Operation state detection unit)

1. An engine system comprising:
an engine;
an intake passage to introduce intake air to the engine;
an exhaust passage to discharge exhaust gas from the engine;
a supercharger provided in the intake passage and the exhaust passage to increase pressure of intake air in the intake passage, the supercharger including a compressor placed in the intake passage, a turbine placed in the exhaust passage, and a rotary shaft connecting the compressor to the turbine to allow the compressor and the turbine to integrally rotate;
an intake amount regulation valve placed in the intake passage to regulate an intake amount of intake air flowing in the intake passage;
an exhaust gas recirculation device including an exhaust gas recirculation passage to allow a part of exhaust gas discharged to the exhaust passage from the engine to flow through the intake passage and recirculate to the engine as exhaust gas recirculation gas, and an exhaust gas recirculation valve to regulate a flow rate of exhaust gas recirculation gas in the exhaust gas recirculation passage, the exhaust gas recirculation passage including an inlet connected to the exhaust passage downstream of the turbine and an outlet connected to the intake passage upstream of the compressor;
a fresh air introduction passage to introduce fresh air to the intake passage downstream of the intake amount regulation valve, the fresh air introduction passage including an inlet connected to the intake passage upstream of the outlet of the exhaust gas recirculation passage;
a fresh air introduction valve to regulate an introduction amount of fresh air flowing to the intake passage from the fresh air introduction passage;
an operation state detecting unit to detect an operation state of the engine; and
a controller to control the intake amount regulation valve, the exhaust gas recirculation valve, and the fresh air introduction valve based on the detected operation state, wherein
the controller is configured to control the fresh air introduction valve to open to a predetermined fresh-air opening degree according to the detected operation state, and the controller controls the exhaust gas recirculation valve to fully close when the controller determines deceleration of the engine based on the detected operation state, controls the fresh air introduction valve to open to the predetermined fresh-air opening degree, and controls the intake amount regulation valve to a predetermined intake opening degree, and thus regulates a total amount of intake air introduced to the engine, and
the controller is configured to control the fresh air introduction valve to open to a predetermined fresh-air opening degree during not-increase in pressure when pressure of the intake air is not increased to positive pressure, and when the controller determines deceleration of the engine based on the detected operation state during not-increase in pressure, the controller controls the exhaust gas recirculation valve to fully close, holds a valve-opening state of the fresh air introduction valve that has been controlled to open to the predetermined fresh-air opening degree, and controls the intake amount regulation valve to close to the predetermined intake opening degree.

2. An engine system comprising:
an engine;
an intake passage to introduce intake air to the engine;
an exhaust passage to discharge exhaust gas from the engine;
a supercharger provided in the intake passage and the exhaust passage to increase pressure of intake air in the intake passage, the supercharger including a compressor placed in the intake passage, a turbine placed in the exhaust passage, and a rotary shaft connecting the compressor to the turbine to allow the compressor and the turbine to integrally rotate;
an intake amount regulation valve placed in the intake passage to regulate an intake amount of intake air flowing in the intake passage;
an exhaust gas recirculation device including an exhaust gas recirculation passage to allow a part of exhaust gas discharged to the exhaust passage from the engine to flow through the intake passage and recirculate to the engine as exhaust gas recirculation gas, and an exhaust gas recirculation valve to regulate a flow rate of exhaust gas recirculation gas in the exhaust gas recirculation passage, the exhaust gas recirculation passage including an inlet connected to the exhaust passage downstream of the turbine and an outlet connected to the intake passage upstream of the compressor;
a fresh air introduction passage to introduce fresh air to the intake passage downstream of the intake amount regulation valve, the fresh air introduction passage including an inlet connected to the intake passage upstream of the outlet of the exhaust gas recirculation passage;
a fresh air introduction valve to regulate an introduction amount of fresh air flowing to the intake passage from the fresh air introduction passage;
an operation state detecting unit to detect an operation state of the engine; and
a controller to control the intake amount regulation valve, the exhaust gas recirculation valve, and the fresh air introduction valve based on the detected operation state, wherein
when the controller determines deceleration of the engine based on the detected operation state during not-increase in pressure when pressure of the intake air is not increased to positive pressure, the controller controls the exhaust gas recirculation valve to fully close, controls the fresh air introduction valve to open from a fully closed state to the predetermined fresh-air opening degree, and after a start of opening control of the fresh air introduction valve, controls the intake amount regulation valve to close to the predetermined intake opening degree.

3. (canceled)

4. The engine system according to claim 1, wherein
the controller is provided with a target fresh-air opening degree map set in advance with a predetermined fresh-air opening degree corresponding to the operation state of the engine, the predetermined fresh-air opening degree including a fully closed position, a maximum opening degree, and various intermediate opening degrees between the fully closed position and the maximum opening degree,
the controller sets the predetermined fresh-air opening degree to the maximum opening degree corresponding to the operation state of the engine at a start of deceleration of the engine by referring to the target fresh-air opening degree map when the controller determines deceleration of the engine during not-increase in pressure so that the controller holds the valve-opening state of the fresh air introduction valve that has been controlled to open to the predetermined fresh-air opening degree,
the controller sets the predetermined fresh-air opening degree to the fully closed position by referring to the target fresh-air opening degree map during pressure increase when the supercharger increases pressure of intake air to positive pressure so that the controller controls the fresh air introduction valve to open to the predetermined fresh-air opening degree, and
the controller determines the predetermined fresh-air opening degree by referring to the target fresh-air opening degree map when the controller determines deceleration of the engine during pressure increase so that the controller controls the fresh air introduction valve to open from a fully closed state to the predetermined fresh-air opening degree after the intake pressure has decreased to negative pressure.

5. The engine system according to claim 1, wherein
the controller calculates a target intake amount of the engine corresponding to the operation state detected at a start of deceleration of the engine, calculates a fresh-air introduction amount corresponding to the predetermined fresh-air opening degree, calculates a passing intake amount of intake air having passed through the intake amount regulation valve by subtracting the fresh-air introduction amount from the target intake amount and calculates the predetermined intake opening degree based on the passing intake amount.

6. The engine system according to claim 1, wherein
the controller gradually decreases the opening degree of the fresh air introduction valve from the predetermined fresh-air opening degree in association with decrease in a ratio of the exhaust gas recirculation gas remaining in the intake passage decreased by introduction of fresh air from the fresh-air introduction passage to the intake passage and gradually increases the opening degree of the intake amount regulation valve according to the gradual decrease in the opening degree of the fresh air introduction valve.

7. The engine system according to claim 6, wherein
the controller once holds the opening degree of the fresh air introduction valve to the predetermined fresh-air opening degree before the gradual decrease in the opening degree of the fresh air introduction valve from the predetermined fresh-air opening degree.

8. The engine system according to claim 5, wherein
the intake amount regulation valve is configured by an electrically operated valve of a direct current motor type, and the fresh air introduction valve is configured by an electrically operated valve of a step motor type, and
the controller increases the predetermined intake opening degree to be calculated by a predetermined value with expecting delay in opening of the fresh air introduction valve.

9. The engine system according to claim 2, wherein
the intake amount regulation valve is configured by an electrically operated valve of a direct current motor type, and the fresh air introduction valve is configured by an electrically operated valve of a step motor type, and
the controller delays a valve-closing start timing of the intake amount regulation valve by a predetermined period of time from a start of opening the fresh air introduction valve with expecting delay in opening of the fresh air introduction valve.

10. The engine system according to claim 2, wherein
the intake amount regulation valve is configured by an electrically operated valve of a direct current motor type, and the fresh air introduction valve is configured by an electrically operated valve of a step motor type, and the controller periodically obtains an actual opening degree of the fresh air introduction valve at each time when the controller controls the fresh air introduction valve to open with expecting delay in opening of the fresh air introduction valve, calculates the intake opening degree corresponding to the obtained actual opening degree, and controls the intake amount regulation valve to close to the calculated intake opening degree.
